(19) United States
(12) Patent Application Publication
(10) Pub. No.: US 2016/0227244 A1
(43) Pub. Date: Aug. 4, 2016

(54) Method, apparatus and system for encoding and decoding video data

(71) Applicant: CANON KABUSHIKI KAISHA, Tokyo (JP)

(72) Inventor: CHRISTOPHER JAMES ROSEWARNE, Concord West (AU)

(21) Appl. No.: 15/021,232

(22) PCT Filed: Sep. 12, 2014
(86) PCT No.: PCT/AU2014/000893

§ 371 Date: Mar. 10, 2016

(30) Foreign Application Priority Data
Sep. 13, 2013 (AU) 2013228045

(51) Int. Cl. H04N 19/593; H04N 19/129; H04N 19/44; H04N 19/105; H04N 19/52; H04N 19/11; H04N 19/137; H04N 19/176; H04N 19/132; H04N 19/70

(52) U.S. Cl. CPC H04N 19/593; H04N 19/132; H04N 19/129; H04N 19/44; H04N 19/70; H04N 19/52; H04N 19/11; H04N 19/137; H04N 19/176; H04N 19/105

(57) ABSTRACT

A method of decoding a coding unit from a video bitstream is disclosed. The coding unit references previously decoded samples. A previous block vector of a previous coding unit to said coding unit to be decoded is determined. The previous coding unit is configured to use intra-block copy. The method decodes, from the video bitstream, a block vector difference for the coding unit to be decoded. The block vector difference indicates a difference between the previous block vector and a block vector of the coding unit to be decoded. The block vector of the coding unit to be decoded is determined using the previous block vector and the block vector difference. The coding unit to be decoded is decoded based on sample values of a reference block selected using the determined block vector.

### TECHNICAL FIELD

The present invention relates generally to digital video signal processing and, in particular, to a method, apparatus and system for encoding and decoding video data. The present invention also relates to a computer program product including a computer readable medium having recorded thereon a computer program for encoding and decoding video data.

### BACKGROUND

Many applications for video coding currently exist, including applications for transmission and storage of video data. Many video coding standards have also been developed and others are currently in development. Recent developments in video coding standardisation have led to the formation of a group called the “Joint Collaborative Team on Video Coding” (JCT-VC). The Joint Collaborative Team on Video Coding (JCT-VC) includes members of Study Group 16, Question 6 (SG16/Q6) of the Telecommunication Standardisation Sector (ITU-T) of the International Telecommunication Union (ITU), known as the Video Coding Experts Group (VCEG), and members of the International Organisations for Standardisation/International Electrotechnical Commission Joint Technical Committee 1/Subcommittee 29/Working Group 11 (ISO/IEC JTC1/SC29/WG11), also known as the Moving Picture Experts Group (MPEG).

The Joint Collaborative Team on Video Coding (JCT-VC) has produced a new video coding standard that significantly outperforms the “H.264/MPEG-4 AVC” video coding standard. The new video coding standard has been named “high efficiency video coding (HEVC)”. Further development of high efficiency video coding (HEVC) is directed towards introducing support of different representations of chroma information present in video data, known as ‘chroma formats’, and support of higher bit-depths. The high efficiency video coding (HEVC) standard defines two profiles, known as ‘Main’ and ‘Main10’, which support a bit-depth of eight (8) bits and ten (10) bits respectively. Further development to increase the bit-depths supported by the high efficiency video coding (HEVC) standard are underway as part of ‘Range extensions’ activity. Support for bit-depths as high as sixteen (16) bits is under study in the Joint Collaborative Team on Video Coding (JCT-VC).

Video data includes one or more colour channels. Typically three colour channels are supported and colour information is represented using a ‘colour space’. One example colour space is known as ‘YCbCr’, although other colour spaces are also possible. The ‘YCbCr’ colour space enables fixed-precision representation of colour information and thus is well suited to digital implementations. The ‘YCbCr’ colour space includes a ‘luma’ channel (Y) and two ‘chroma’ channels (Cb and Cr). Each colour channel has a particular bit-depth. The bit-depth defines the width of samples in the respective colour channel in bits. Generally, all colour channels have the same bit-depth, although the colour channels may also have different bit-depths.

One aspect of the coding efficiency achievable with a particular video coding standard is the characteristics of available prediction methods. For video coding standards intended for compression sequences of two-dimensional video frames, there are three types of prediction: intra-prediction, inter-prediction and intra block copy mode. Frames are divided into one or more blocks, and each block is predicted using one of the types of prediction. Intra-prediction methods allow content of one part of a video frame to be predicted from other parts of the same video frame. Intra-prediction methods typically produce a block having a directional texture, with an intra-prediction mode specifying the direction of the texture and neighbouring samples within a frame used as a basis to produce the texture. Inter-prediction methods allow the content of a block within a video frame to be predicted from blocks in previous video frames. The previous video frames (i.e. in ‘decoding order’ as opposed to ‘display order’ which may be different) may be referred to as ‘reference frames’. Intra block copy mode creates a reference block from another block located within the current frame. The first video frame within a sequence of video frames typically uses intra-prediction for all blocks within the frame, as no prior frame is available for reference. Subsequent video frames may use one or more previous video frames from which to predict blocks.

To achieve the highest coding efficiency, the prediction method that produces a predicted block that is closest to captured frame data is typically used. The remaining difference between the predicted block and the captured frame data is known as the ‘residual’. This spatial domain representation of the difference is generally transformed into a frequency domain representation. Generally, the frequency domain representation compactly stores the information present in the spatial domain representation. The frequency domain representation includes a block of ‘residual coefficients’ that results from applying a transform, such as an integer discrete cosine transform (DCT). Moreover, the residual coefficients (or ‘scaled transform coefficients’) are quantised, which introduces loss but also further reduces the amount of information required to be encoded in a bitstream. The lossy frequency domain representation of the residual, also known as ‘transform coefficients’, may be stored in the bitstream. The amount of lossiness in the residual recovered in a decoder affects the distortion of video data decoded from the bitstream compared to the captured frame data and the size of the bitstream.

A video bitstream includes a sequence of encoded syntax elements. The syntax elements are ordered according to a hierarchy of ‘syntax structures’. A syntax structure describes a set of syntax elements and the conditions under which each syntax element is coded. A syntax structure may invoke other syntax structures, enabling hierarchy arrangements of syntax elements. A syntax structure may also invoke another instance of the same syntax structure, enabling recursive arrangements of syntax elements. Each syntax element is composed of one or more ‘bins’, which are encoded using a ‘context adaptive binary arithmetic coding’ algorithm. A given bin may be ‘bypass’ coded, in which case there is no ‘context’ associated with the bin. Alternatively, a bin may be ‘context’ coded, in which case there is context associated with the bin. Each context coded bin has one context associated with the bin. The context is selected from one or more possible contexts. The context is retrieved from a memory and each time the context is used, the context is also updated and stored back in the memory. When two or more contexts may be used for a given bin, a rule to determine which context to use is applied at the video encoder and the video decoder. When encoding or decoding the bin, prior information in the bitstream is used to select which context to use. Context information in the decoder necessarily tracks context information in the encoder (otherwise the decoder could not parse a bitstream produced by an encoder). The context includes two parameters: a likely bin value (or ‘valMPS’) and a probability level.

Syntax elements with two distinct values may also be referred to as ‘flags’ and are generally encoded using one context coded bin. A given syntax structure defines the possible syntax elements that can be included in the video bitstream and the circumstances in which each syntax element is included in the video bitstream. Each instance of a syntax element contributes to the size of the video bitstream. An objective of video compression is to enable representation of a given sequence using a video bitstream and having minimal size (e.g. in bytes) for a given quality level (including both lossy and lossless cases). At the same time, video decoders are invariably required to decode video bitstreams in real time, placing limits on the complexity of the algorithms that can be used. As such, a trade-off between algorithmic complexity and compression performance is made. In particular, modifications that can improve or maintain compression performance while reducing algorithmic complexity are desirable.

### SUMMARY

It is an object of the present invention to substantially overcome, or at least ameliorate, one or more disadvantages of existing arrangements.

According to one aspect of the present disclosure, there is provided a method of decoding a coding unit from a video bitstream, the coding unit referencing previously decoded samples, the method comprising:

determining a previous block vector of a previous coding unit to said coding unit to be decoded, the previous coding unit being configured to use intra-block copy;

decoding, from the video bitstream, a block vector difference for said coding unit to be decoded, the block vector difference indicating a difference between the previous block vector and a block vector of said coding unit to be decoded;

determining the block vector of said coding unit to be decoded using the previous block vector and the block vector difference; and

decoding said coding unit to be decoded, based on sample values of a reference block selected using the determined block vector.

According to another aspect of the present disclosure, there is provided a system for decoding a coding unit from a video bitstream, the coding unit referencing previously decoded samples, the system comprising:

a memory for storing data and a computer program;

a processor coupled to said memory, the computer program comprising instructions for:
determining a previous block vector of a previous coding unit to said coding unit to be decoded, the previous coding unit being configured to use intra-block copy;
decoding, from the video bitstream, a block vector difference for said coding unit to be decoded, the block vector difference indicating a difference between the previous block vector and a block vector of said coding unit to be decoded;
determining the block vector of said coding unit to be decoded using the previous block vector and the block vector difference; and
decoding said coding unit to be decoded, based on sample values of a reference block selected using the determined block vector.

According to still another aspect of the present disclosure, there is provided an apparatus for decoding a coding unit from a video bitstream, the coding unit referencing previously decoded samples, the apparatus comprising:

means for determining a previous block vector of a previous coding unit to said coding unit to be decoded, the previous coding unit being configured to use intra-block copy;

means for decoding, from the video bitstream, a block vector difference for said coding unit to be decoded, the block vector difference indicating a difference between the previous block vector and a block vector of said coding unit to be decoded;

means for determining the block vector of said coding unit to be decoded using the previous block vector and the block vector difference; and

means for decoding said coding unit to be decoded, based on sample values of a reference block selected using the determined block vector.

According to still another aspect of the present disclosure, there is provided a non-transitory computer readable medium having a computer program stored thereon for decoding a coding unit from a video bitstream, the coding unit referencing previously decoded samples, the program comprising:

code for determining a previous block vector of a previous coding unit to said coding unit to be decoded, the previous coding unit being configured to use intra-block copy;

code for decoding, from the video bitstream, a block vector difference for said coding unit to be decoded, the block vector difference indicating a difference between the previous block vector and a block vector of said coding unit to be decoded;

code for determining the block vector of said coding unit to be decoded using the previous block vector and the block vector difference; and

code for decoding said coding unit to be decoded, based on sample values of a reference block selected using the determined block vector.

According to still another aspect of the present disclosure, there is provided a method of encoding a coding unit into a video bitstream, the method comprising:

determining a previous block vector of a previous coding unit to said coding unit to be encoded, the previous coding unit being configured to use intra-block copy;

determining a block vector difference for said coding unit to be encoded, the block vector difference indicating the difference between the previous block vector and a block vector of said coding unit to be encoded;

encoding, into the video bitstream, the block vector difference for said coding unit to be encoded;

encoding said coding unit to be encoded into the video bitstream, using sample values of a reference block selected using the block vector of said coding unit to be encoded.

According to still another aspect of the present disclosure, there is provided a system for encoding a coding unit into a video bitstream, the system comprising:

a memory for storing data and a computer program;

a processor coupled to said memory, the computer program comprising instructions for:
determining a previous block vector of a previous coding unit to said coding unit to be encoded, the previous coding unit being configured to use intra-block copy;
determining a block vector difference for said coding unit to be encoded, the block vector difference indicating the difference between the previous block vector and a block vector of said coding unit to be encoded;
encoding, into the video bitstream, the block vector difference for said coding unit to be encoded;
encoding said coding unit to be encoded into the video bitstream, using sample values of a reference block selected using the block vector of said coding unit to be encoded.

According to still another aspect of the present disclosure, there is provided an apparatus for encoding a coding unit into a video bitstream, the apparatus comprising:

means for determining a previous block vector of a previous coding unit to said coding unit to be encoded, the previous coding unit being configured to use intra-block copy;

means for determining a block vector difference for said coding unit to be encoded, the block vector difference indicating the difference between the previous block vector and a block vector of said coding unit to be encoded;

means for encoding, into the video bitstream, the block vector difference for said coding unit to be encoded;

means for encoding said coding unit to be encoded into the video bitstream, using sample values of a reference block selected using the block vector of said coding unit to be encoded.

According to still another aspect of the present disclosure, there is provided a non-transitory computer readable medium having a computer program stored thereon for encoding a coding unit into a video bitstream, the program comprising:

determining a previous block vector of a previous coding unit to said coding unit to be encoded, the previous coding unit being configured to use intra-block copy;

determining a block vector difference for said coding unit to be encoded, the block vector difference indicating the difference between the previous block vector and a block vector of said coding unit to be encoded;

encoding, into the video bitstream, the block vector difference for said coding unit to be encoded;

encoding said coding unit to be encoded into the video bitstream, using sample values of a reference block selected using the block vector of said coding unit to be encoded.

According to still another aspect of the present disclosure, there is provided a method of decoding a block from a video bitstream, the block referencing previously decoded samples, the method comprising:

determining a prediction mode from the video bitstream;

decoding an intra block copy flag from the video bitstream if the determined prediction mode is intra-prediction, the intra block copy flag indicating that current samples are based on previously decoded samples of a current frame; and

decoding the block from the video bitstream, based on the decoded intra block copy flag, by determining sample values for the block from the previously decoded samples.

According to still another aspect of the present disclosure, there is provided a system for decoding a block from a video bitstream, the block referencing previously decoded samples, the system comprising:

a memory for storing data and a computer program;

a processor coupled to the memory, the computer program comprising instructions for:
determining a prediction mode from the video bitstream; decoding an intra block copy flag from the video bitstream if the determined prediction mode is intra-prediction, the intra block copy flag indicating that current samples are based on previously decoded samples of a current frame; and
decoding the block from the video bitstream, based on the decoded intra block copy flag, by determining sample values for the block from the previously decoded samples.

According to still another aspect of the present disclosure, there is provided an apparatus for decoding a block from a video bitstream, the block referencing previously decoded samples, the apparatus comprising:

means for determining a prediction mode from the video bitstream;

means for decoding an intra block copy flag from the video bitstream if the determined prediction mode is intra-prediction, the intra block copy flag indicating that current samples are based on previously decoded samples of a current frame; and

means for decoding the block from the video bitstream, based on the decoded intra block copy flag, by determining sample values for the block from the previously decoded samples.

According to still another aspect of the present disclosure, there is provided a non-transitory computer readable medium having a computer program stored thereon for method of decoding a block from a video bitstream, the block referencing previously decoded samples, the program comprising:

code for determining a prediction mode from the video bitstream;

code for decoding an intra block copy flag from the video bitstream if the determined prediction mode is intra-prediction, the intra block copy flag indicating that current samples are based on previously decoded samples of a current frame; and

code for decoding the block from the video bitstream, based on the decoded intra block copy flag, by determining sample values for the block from the previously decoded samples.

Other aspects are also disclosed.

### BRIEF DESCRIPTION OF THE DRAWINGS

At least one embodiment of the present invention will now be described with reference to the following drawings and appendices, in which:

FIG. 1 is a schematic block diagram showing a video encoding and decoding system;

FIGS. 2A and 2B form a schematic block diagram of a general purpose computer system upon which one or both of the video encoding and decoding system of FIG. 1 may be practiced;

FIG. 3 is a schematic block diagram showing functional modules of a video encoder;

FIG. 4 is a schematic block diagram showing functional modules of a video decoder;

FIG. 5 is a schematic block diagram showing a frame that is divided into two tiles and three slice segments;

FIG. 6A is a schematic block diagram showing an example ‘Z-scan’ order of scanning coding units (CUs) within a coding tree block (CTB);

FIG. 6B is a schematic block diagram showing an example block vector referencing a block of samples in a neighbouring coding tree block (CTB) relative to a coding unit (CU) within a current coding tree block (CTB);

FIG. 7A is a schematic block diagram showing an example block vector referencing a block of samples in a neighbouring coding tree block (CTB) relative to a coding unit (CU) within a current coding tree block (CTB);

FIG. 7B is a schematic block diagram showing an example block vector referencing a block of samples spanning both a current coding tree block (CTB) and a neighbouring coding tree block (CTB);

FIG. 8A is a schematic block diagram showing an example block vector referencing a block of samples spanning both a current coding tree block (CTB) and a neighbouring coding tree block (CTB) that is marked as being unavailable;

FIG. 8B is a schematic block diagram showing an example adjusted block vector referencing a block of samples within a current coding tree block (CTB);

FIG. 8C is a schematic block diagram showing an example block vector referencing a block of samples where some of the referenced samples were decoded using inter-prediction;

FIG. 8D is a schematic block diagram showing an example block vector referencing a block of samples where a reference block includes samples within a current coding unit (CU);

FIG. 9 is a schematic block diagram showing a coding unit (CU) syntax structure;

FIG. 10 is a schematic flow diagram showing a method of encoding a coding unit (CU) syntax structure into an encoded bitstream;

FIG. 11 is a schematic flow diagram showing a method of decoding a coding unit (CU) syntax structure from an encoded bitstream;

FIG. 12A is a schematic block diagram showing context selection for an intra block copy flag for a coding unit (CU);

FIG. 12B is a schematic block diagram showing context selection for an intra block copy flag for a coding unit (CU) aligned to the top of a coding tree block (CTB);

FIG. 13 is a schematic block diagram showing functional modules of the entropy decoder of FIG. 4;

FIG. 14 is a schematic flow diagram showing a method of decoding an intra block copy flag for a coding unit (CU);

FIG. 15A is a schematic flow diagram showing a method of determining a prediction mode for a coding unit (CU);

FIG. 15B is a schematic flow diagram showing a method of determining a prediction mode for a coding unit (CU);

FIG. 16 is a schematic block diagram showing a residual quad-tree (RQT) in a coding unit (CU) within a coding tree block (CTB);

FIG. 17A is a schematic flow diagram showing a method of generating a reference sample block for a coding unit (CU) configured to use the intra block copy mode;

FIG. 17B is a schematic flow diagram showing a method of generating a reference sample block for a coding unit (CU) configured to use an intra block copy mode;

FIG. 17C is a schematic flow diagram showing a method of generating a reference sample block for a coding unit (CU) configured to use an intra block copy mode;

FIG. 17D is a schematic flow diagram showing a method of generating a reference sample block for a coding unit (CU) configured to use an intra block copy mode;

FIG. 18A is a schematic block diagram showing an example block vector referencing a block of samples where the origin of the block vector is relative to a point other than the current coding unit (CU) location; and

FIG. 18B is a schematic block diagram showing an example block vector representation between successive coding units (CUs) configured to use an intra block copy mode;

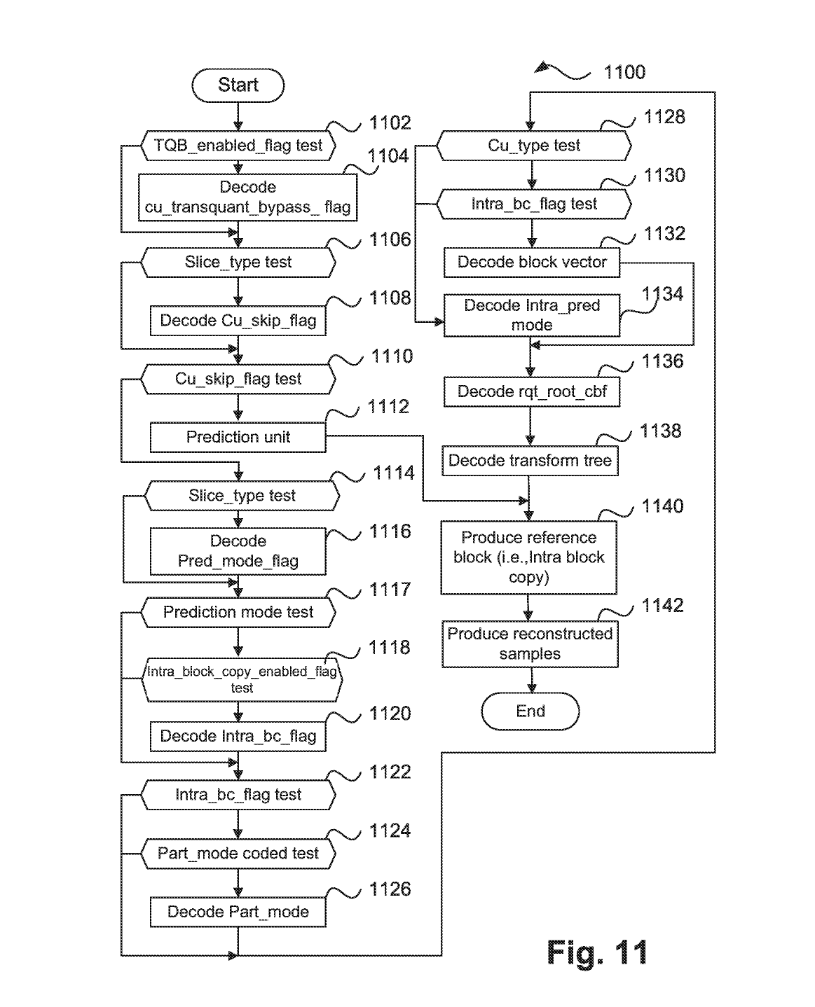

Appendix A shows a coding unit (CU) syntax structure according to the method of FIG. 11;

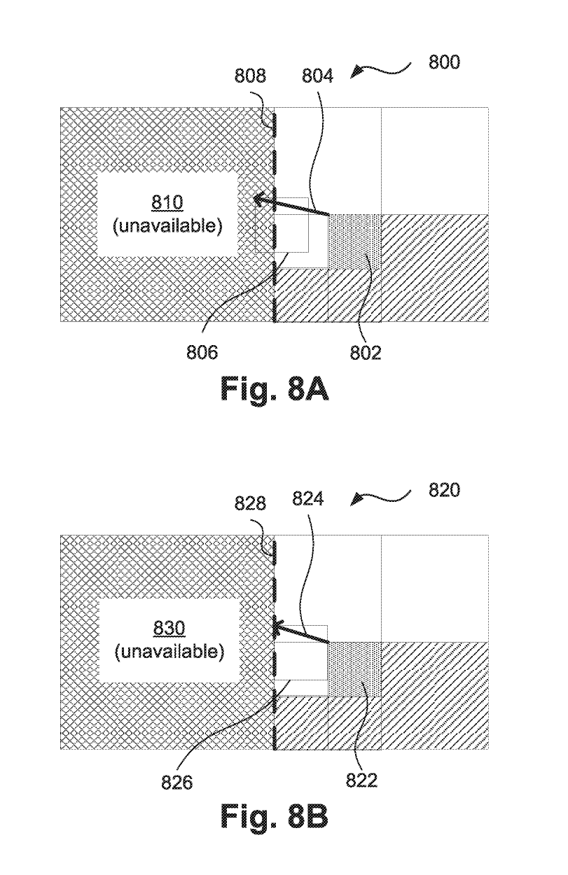

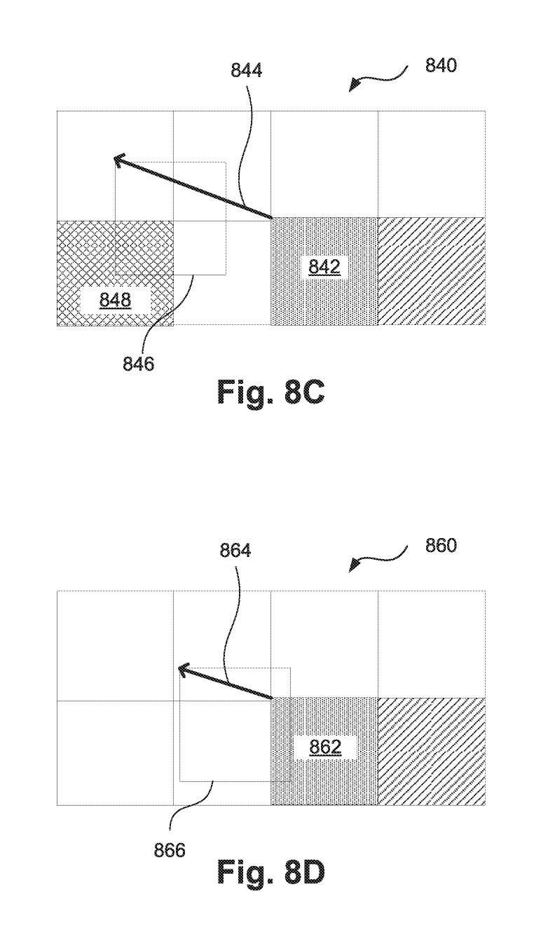

Appendix B shows a block vector conformance restriction according to FIG. 8C;

Appendix C shows an intra block copy method according to FIG. 8C;

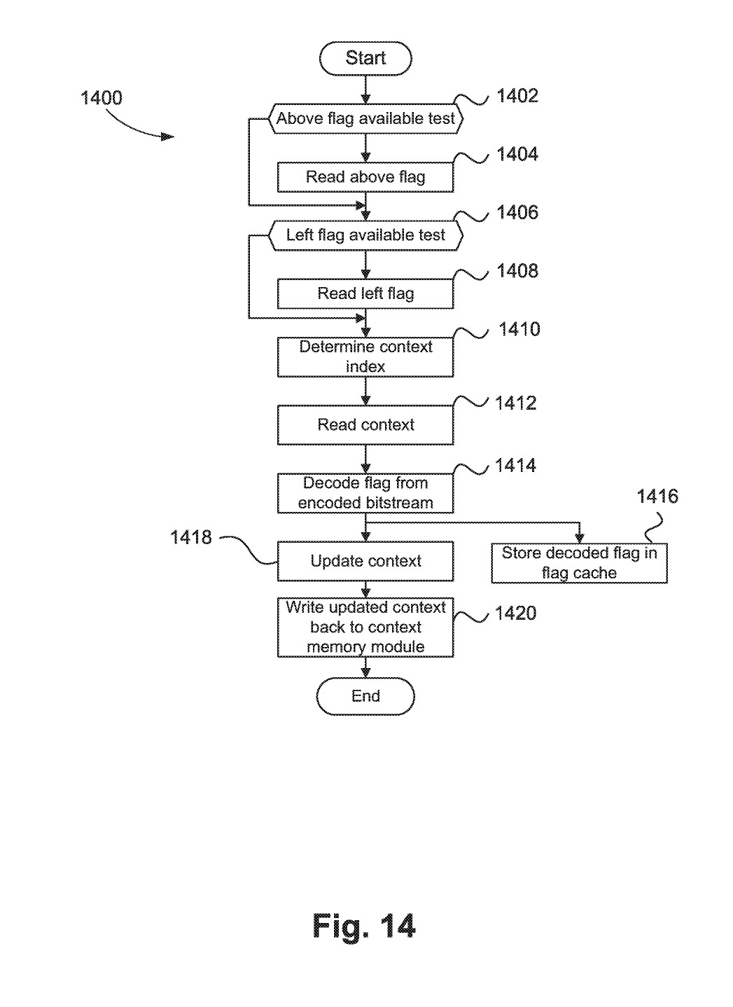

Appendix D shows a context selection for intra_bc_flag according to an arrangement of the method of FIG. 14 with steps 1402-1408 omitted.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

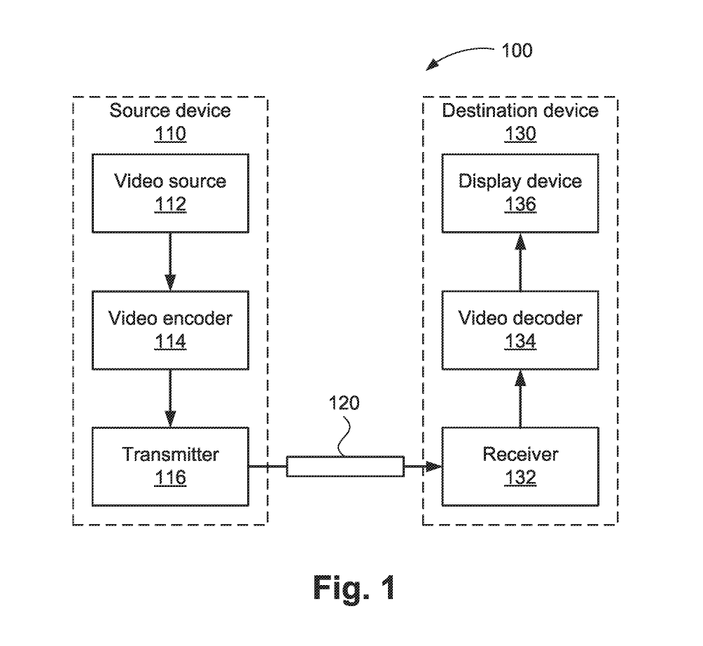

FIG. 1 is a schematic block diagram showing function modules of a video encoding and decoding system 100. The system 100 may utilise intra block copy techniques to reduce complexity, improve coding efficiency and improve error resilience. Complexity may be reduced by reducing the number of contexts present in the system 100 or by simplifying or removing rules used to select which context to use for a given context coded bin. The system 100 includes a source device 110 and a destination device 130. A communication channel 120 is used to communicate encoded video information from the source device 110 to the destination device 130. In some arrangements, the source device 110 and destination device 130 may comprise respective mobile telephone hand-sets, in which case the communication channel 120 is a wireless channel. In other arrangements, the source device 110 and destination device 130 may comprise video conferencing equipment, in which case the communication channel 120 is typically a wired channel, such as an internet connection. Moreover, the source device 110 and the destination device 130 may comprise any of a wide range of devices, including devices supporting over the air television broadcasts, cable television applications, internet video applications and applications where encoded video data is captured on some storage medium or a file server.

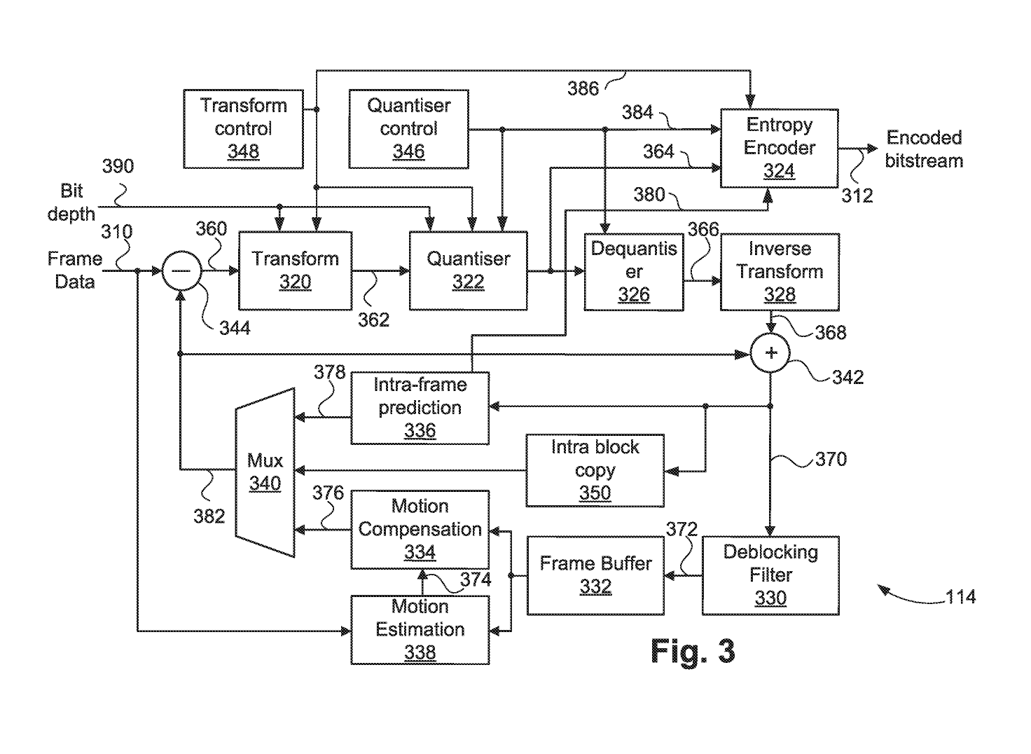

As shown in FIG. 1, the source device 110 includes a video source 112, a video encoder 114 and a transmitter 116. The video source 112 typically comprises a source of captured video frame data, such as an imaging sensor, a previously captured video sequence stored on a non-transitory recording medium, or a video feed from a remote imaging sensor. Examples of source devices 110 that may include an imaging sensor as the video source 112 include smart-phones, video camcorders and network video cameras. The video encoder 114 converts the captured frame data from the video source 112 into encoded video data and will be described further with reference to FIG. 3. The encoded video data is typically transmitted by the transmitter 116 over the communication channel 120 as encoded video data (or “encoded video information”). It is also possible for the encoded video data to be stored in some storage device, such as a “Flash” memory or a hard disk drive, until later being transmitted over the communication channel 120.

The destination device 130 includes a receiver 132, a video decoder 134 and a display device 136. The receiver 132 receives encoded video data from the communication channel 120 and passes received video data to the video decoder 134. The video decoder 134 then outputs decoded frame data to the display device 136. Examples of the display device 136 include a cathode ray tube, a liquid crystal display, such as in smart-phones, tablet computers, computer monitors or in stand-alone television sets. It is also possible for the functionality of each of the source device 110 and the destination device 130 to be embodied in a single device.

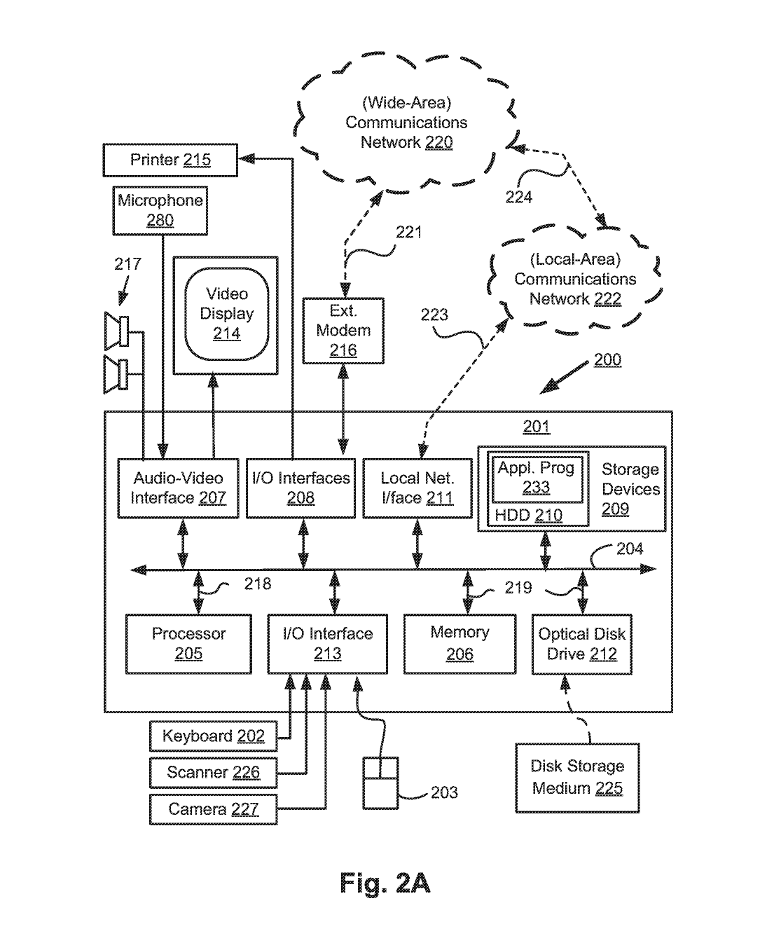

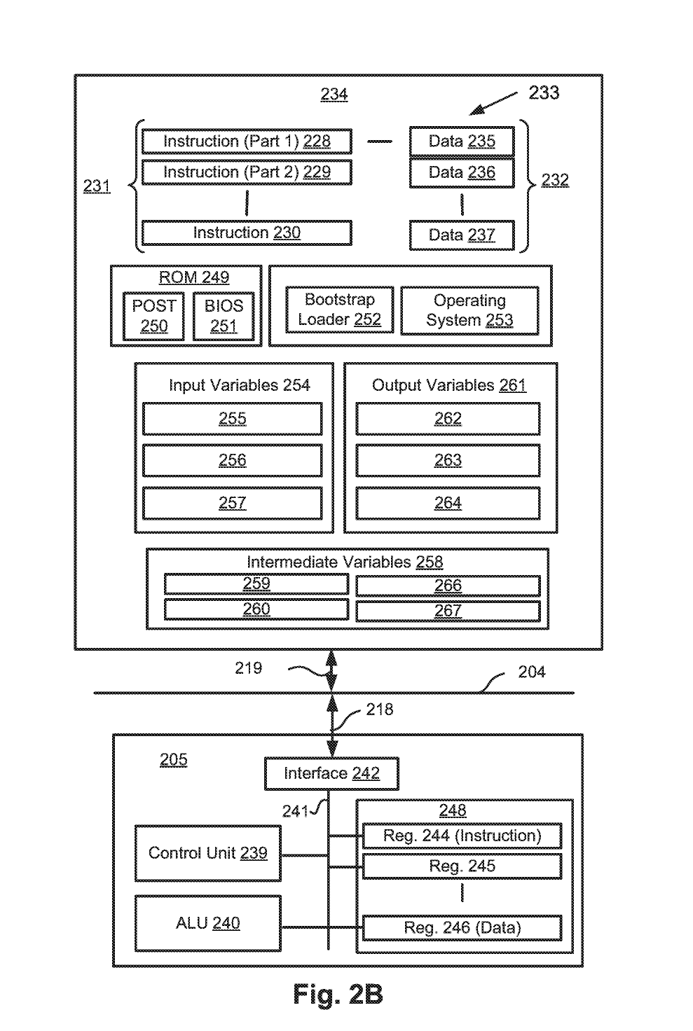

Notwithstanding the example devices mentioned above, each of the source device 110 and destination device 130 may be configured within a general purpose computing system, typically through a combination of hardware and software components. FIG. 2A illustrates such a computer system 200, which includes: a computer module 201; input devices such as a keyboard 202, a mouse pointer device 203, a scanner 226, a camera 227, which may be configured as the video source 112, and a microphone 280; and output devices including a printer 215, a display device 214, which may be configured as the display device 136, and loudspeakers 217. An external Modulator-Demodulator (Modem) transceiver device 216 may be used by the computer module 201 for communicating to and from a communications network 220 via a connection 221. The communications network 220, which may represent the communication channel 120, may be a wide-area network (WAN), such as the Internet, a cellular telecommunications network, or a private WAN. Where the connection 221 is a telephone line, the modem 216 may be a traditional “dial-up” modem. Alternatively, where the connection 221 is a high capacity (e.g., cable) connection, the modem 216 may be a broadband modem. A wireless modem may also be used for wireless connection to the communications network 220. The transceiver device 216 may provide the functionality of the transmitter 116 and the receiver 132 and the communication channel 120 may be embodied in the connection 221.

The computer module 201 typically includes at least one processor unit 205, and a memory unit 206. For example, the memory unit 206 may have semiconductor random access memory (RAM) and semiconductor read only memory (ROM). The computer module 201 also includes an number of input/output (I/O) interfaces including: an audio-video interface 207 that couples to the video display 214, loudspeakers 217 and microphone 280; an I/O interface 213 that couples to the keyboard 202, mouse 203, scanner 226, camera 227 and optionally a joystick or other human interface device (not illustrated); and an interface 208 for the external modem 216 and printer 215. In some implementations, the modem 216 may be incorporated within the computer module 201, for example within the interface 208. The computer module 201 also has a local network interface 211, which permits coupling of the computer system 200 via a connection 223 to a local-area communications network 222, known as a Local Area Network (LAN). As illustrated in FIG. 2A, the local communications network 222 may also couple to the wide network 220 via a connection 224, which would typically include a so-called “firewall” device or device of similar functionality. The local network interface 211 may comprise an Ethernet™ circuit card, a Bluetooth™ wireless arrangement or an IEEE 802.11 wireless arrangement. However, numerous other types of interfaces may be practiced for the interface 211. The local network interface 211 may also provide the functionality of the transmitter 116 and the receiver 132 and communication channel 120 may also be embodied in the local communications network 222.

The I/O interfaces 208 and 213 may afford either or both of serial and parallel connectivity, the former typically being implemented according to the Universal Serial Bus (USB) standards and having corresponding USB connectors (not illustrated). Storage devices 209 are provided and typically include a hard disk drive (HDD) 210. Other storage devices such as a floppy disk drive and a magnetic tape drive (not illustrated) may also be used. An optical disk drive 212 is typically provided to act as a non-volatile source of data. Portable memory devices, such optical disks (e.g. CD-ROM, DVD, Blu-ray Disc™) USB-RAM, portable, external hard drives, and floppy disks, for example, may be used as appropriate sources of data to the computer system 200. Typically, any of the HDD 210, optical drive 212, networks 220 and 222 may also be configured to operate as the video source 112, or as a destination for decoded video data to be stored for reproduction via the display 214.

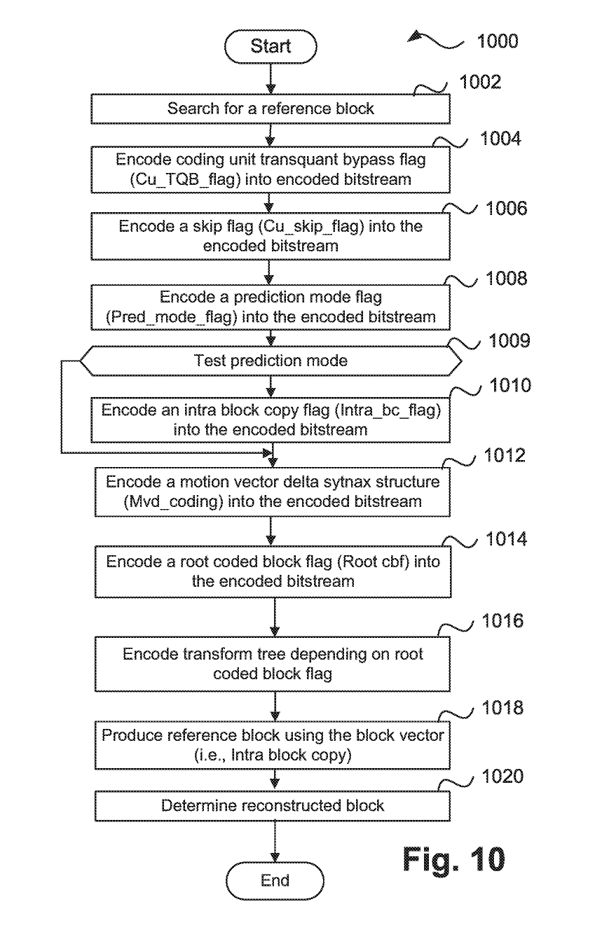

The components 205 to 213 of the computer module 201 typically communicate via an interconnected bus 204 and in a manner that results in a conventional mode of operation of the computer system 200 known to those in the relevant art. For example, the processor 205 is coupled to the system bus 204 using a connection 218. Likewise, the memory 206 and optical disk drive 212 are coupled to the system bus 204 by connections 219. Examples of computers on which the described arrangements can be practised include IBM-PC's and compatibles, Sun SPARCstations, Apple Mac™ or alike computer systems.

Where appropriate or desired, the video encoder 114 and the video decoder 134, as well as methods described below, may be implemented using the computer system 200. In particular, the video encoder 114, the video decoder 134 and the methods of FIGS. 10, 11, 14, 15A, 15B, 17A, 17B, 17C and 17D to be described, may be implemented as one or more software application programs 233 executable within the computer system 200. The video encoder 114, the video decoder 134 and the steps of the described methods may be effected by instructions 231 (see FIG. 2B) in the software 233 that are carried out within the computer system 200. The software instructions 231 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software may be stored in a computer readable medium, including the storage devices described below, for example. The software is loaded into the computer system 200 from the computer readable medium, and then executed by the computer system 200. A computer readable medium having such software or computer program recorded on the computer readable medium is a computer program product. The use of the computer program product in the computer system 200 preferably effects an advantageous apparatus for implementing the video encoder 114, the video decoder 134 and the described methods.

The software 233 is typically stored in the HDD 210 or the memory 206. The software is loaded into the computer system 200 from a computer readable medium, and executed by the computer system 200. Thus, for example, the software 233 may be stored on an optically readable disk storage medium (e.g., CD-ROM) 225 that is read by the optical disk drive 212.

In some instances, the application programs 233 may be supplied to the user encoded on one or more CD-ROMs 225 and read via the corresponding drive 212, or alternatively may be read by the user from the networks 220 or 222. Still further, the software can also be loaded into the computer system 200 from other computer readable media. Computer readable storage media refers to any non-transitory tangible storage medium that provides recorded instructions and/or data to the computer system 200 for execution and/or processing. Examples of such storage media include floppy disks, magnetic tape, CD-ROM, DVD, Blu-ray Disc, a hard disk drive, a ROM or integrated circuit, USB memory, a magneto-optical disk, or a computer readable card such as a PCMCIA card and the like, whether or not such devices are internal or external of the computer module 201. Examples of transitory or non-tangible computer readable transmission media that may also participate in the provision of the software, application programs, instructions and/or video data or encoded video data to the computer module 401 include radio or infra-red transmission channels as well as a network connection to another computer or networked device, and the Internet or Intranets including e-mail transmissions and information recorded on Websites and the like.

The second part of the application programs 233 and the corresponding code modules mentioned above may be executed to implement one or more graphical user interfaces (GUIs) to be rendered or otherwise represented upon the display 214. Through manipulation of typically the keyboard 202 and the mouse 203, a user of the computer system 200 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 217 and user voice commands input via the microphone 280.

FIG. 2B is a detailed schematic block diagram of the processor 205 and a “memory” 234. The memory 234 represents a logical aggregation of all the memory modules (including the HDD 209 and semiconductor memory 206) that can be accessed by the computer module 201 in FIG. 2A.

When the computer module 201 is initially powered up, a power-on self-test (POST) program 250 executes. The POST program 250 is typically stored in a ROM 249 of the semiconductor memory 206 of FIG. 2A. A hardware device such as the ROM 249 storing software is sometimes referred to as firmware. The POST program 250 examines hardware within the computer module 201 to ensure proper functioning and typically checks the processor 205, the memory 234 (209, 206), and a basic input-output systems software (BIOS) module 251, also typically stored in the ROM 249, for correct operation. Once the POST program 250 has run successfully, the BIOS 251 activates the hard disk drive 210 of FIG. 2A. Activation of the hard disk drive 210 causes a bootstrap loader program 252 that is resident on the hard disk drive 210 to execute via the processor 205. This loads an operating system 253 into the RAM memory 206, upon which the operating system 253 commences operation. The operating system 253 is a system level application, executable by the processor 205, to fulfil various high level functions, including processor management, memory management, device management, storage management, software application interface, and generic user interface.

The operating system 253 manages the memory 234 (209, 206) to ensure that each process or application running on the computer module 201 has sufficient memory in which to execute without colliding with memory allocated to another process. Furthermore, the different types of memory available in the computer system 200 of FIG. 2A must be used properly so that each process can run effectively. Accordingly, the aggregated memory 234 is not intended to illustrate how particular segments of memory are allocated (unless otherwise stated), but rather to provide a general view of the memory accessible by the computer system 200 and how such is used.

As shown in FIG. 2B, the processor 205 includes a number of functional modules including a control unit 239, an arithmetic logic unit (ALU) 240, and a local or internal memory 248, sometimes called a cache memory. The cache memory 248 typically includes a number of storage registers 244-246 in a register section. One or more internal busses 241 functionally interconnect these functional modules. The processor 205 typically also has one or more interfaces 242 for communicating with external devices via the system bus 204, using a connection 218. The memory 234 is coupled to the bus 204 using a connection 219.

The application program 233 includes a sequence of instructions 231 that may include conditional branch and loop instructions. The program 233 may also include data 232 which is used in execution of the program 233. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228 and 229.

In general, the processor 205 is given a set of instructions which are executed therein. The processor 205 waits for a subsequent input, to which the processor 205 reacts to by executing another set of instructions. Each input may be provided from one or more of a number of sources, including data generated by one or more of the input devices +202, 203, data received from an external source across one of the networks 220, 202, data retrieved from one of the storage devices 206, 209 or data retrieved from a storage medium 225 inserted into the corresponding reader 212, all depicted in FIG. 2A. The execution of a set of the instructions may in some cases result in output of data. Execution may also involve storing data or variables to the memory 234.

The video encoder 114, the video decoder 134 and the described methods may use input variables 254, which are stored in the memory 234 in corresponding memory locations 255, 256, 257. The video encoder 114, the video decoder 134 and the described methods produce output variables 261, which are stored in the memory 234 in corresponding memory locations 262, 263, 264. Intermediate variables 258 may be stored in memory locations 259, 260, 266 and 267.

Referring to the processor 205 of FIG. 2B, the registers 244, 245, 246, the arithmetic logic unit (ALU) 240, and the control unit 239 work together to perform sequences of micro-operations needed to perform “fetch, decode, and execute” cycles for every instruction in the instruction set making up the program 233. Each fetch, decode, and execute cycle comprises:

(a) a fetch operation, which fetches or reads an instruction 231 from a memory location 228, 229, 230;

(b) a decode operation in which the control unit 239 determines which instruction has been fetched; and

(c) an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to a memory location 232.

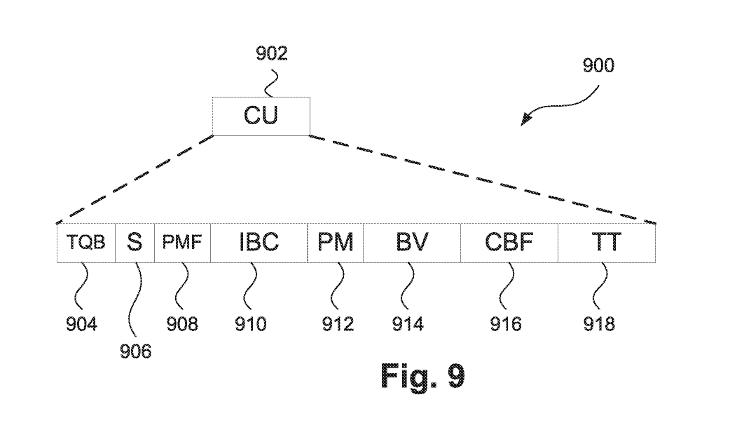

Each step or sub-process in the methods FIGS. 9 and 10 to be described is associated with one or more segments of the program 233 and is typically performed by the register section 244, 245, 247, the ALU 240, and the control unit 239 in the processor 205 working together to perform the fetch, decode, and execute cycles for every instruction in the instruction set for the noted segments of the program 233.

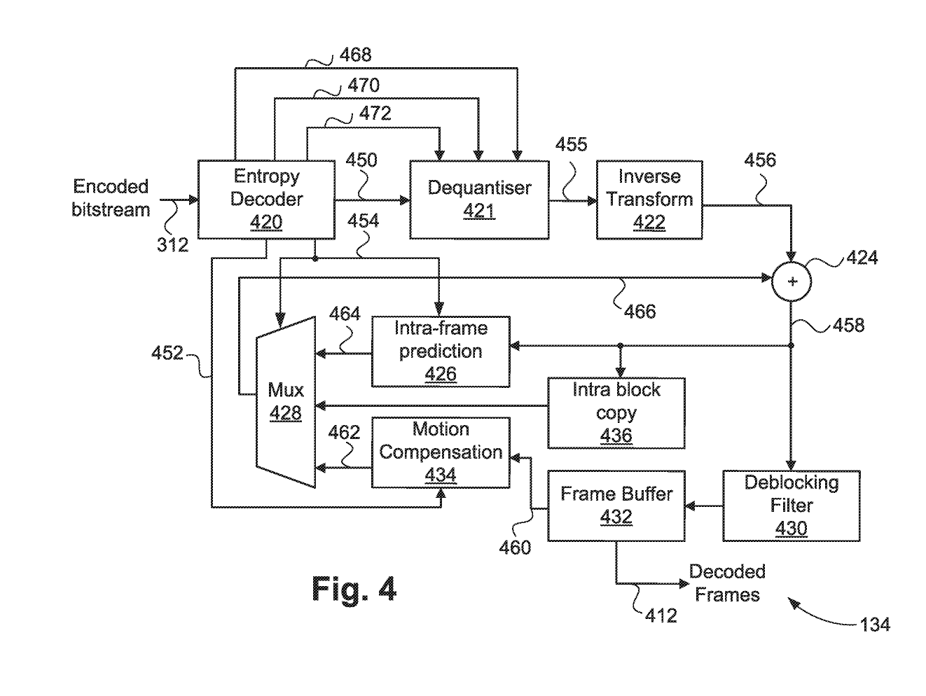

FIG. 3 is a schematic block diagram showing functional modules of the video encoder 114. FIG. 4 is a schematic block diagram showing functional modules of the video decoder 134. Generally, data is passed between functional modules of the video encoder 114 and the video decoder 134 in blocks or arrays such as, for example, blocks of samples or blocks of transform coefficients. Where a functional module is described with reference to the behaviour of individual array elements (e.g., samples or transform coefficients), the behaviour shall be understood to be applied to all array elements.

The video encoder 114 and video decoder 134 may be implemented using a general-purpose computer system 200, as shown in FIGS. 2A and 2B, where the various functional modules may be implemented by dedicated hardware within the computer system 200. Alternatively, the various functional modules of the video encoder 114 and video decoder 134 may be implemented by software executable within the computer system 200, such as one or more software code modules of the software application program 233 resident on the hard disk drive 205 and being controlled in its execution by the processor 205. In another alternative, the various functional modules of the video encoder 114 and video decoder 134 may be implemented by a combination of dedicated hardware and software executable within the computer system 200. The video encoder 114, the video decoder 134 and the described methods may alternatively be implemented in dedicated hardware, such as one or more integrated circuits performing the functions or sub functions of the described methods. Such dedicated hardware may include graphic processors, digital signal processors, application specific integrated circuits (ASICs), field programmable gate arrays (FPGAs) or one or more microprocessors and associated memories. In particular, the video encoder 114 comprises modules 320-350 and the video decoder 134 comprises modules 420-436 which may each be implemented as one or more software code modules of the software application program 233.

Although the video encoder 114 of FIG. 3 is an example of a high efficiency video coding (HEVC) video encoding pipeline, other video codecs may also be used to perform the processing stages described herein. The video encoder 114 receives captured frame data, such as a series of frames, each frame including one or more colour channels.

The video encoder 114 divides each frame of the captured frame data, such as frame data 310, into regions generally referred to as ‘coding tree blocks’ (CTBs). The frame data 310 includes one or more colour planes. Each colour plane includes samples. Each sample occupies a binary word sized according to a bit-depth 390. Thus, the range of possible sample values is defined by the bit-depth 390. For example, if the bit-depth 390 is set to eight (8) bits, sample values may be from zero (0) to two hundred and fifty five (255). Each coding tree block (CTB) includes a hierarchical quad-tree subdivision of a portion of the frame into a collection of ‘coding units’ (CUs). A coding tree block (CTB) generally occupies an area of 64×64 luma samples, although other sizes are possible, such as 16×16 or 32×32. In some cases even larger sizes for the coding tree block (CTB), such as 128×128 luma samples, may be used. The coding tree block (CTB) may be sub-divided via a split into four equal sized regions to create a new hierarchy level. Splitting may be applied recursively, resulting in a quad-tree hierarchy (or “coding tree”). As the coding tree block (CTB) side dimensions are powers of two and the quad-tree splitting results in a halving of the width and height, the region side dimensions are also powers of two. When no further split of a region is performed, a ‘coding unit’ (CU) is said to exist within the region. When no split is performed at the top level (or typically the “highest level”) of the coding tree block, the region occupying the entire coding tree block contains one coding unit (CU). In such cases, the coding unit (CU) is generally referred to as a ‘largest coding unit’ (LCU). A minimum size also exists for each coding unit (CU), such as the area occupied by 8×8 luma samples, although other minimum sizes are also possible (e.g. 16×16 luma samples or 32×32 luma samples). Coding units of the minimum size are generally referred to as ‘smallest coding units’ (SCUs). As a result of the quad-tree hierarchy, the entirety of the coding tree block (CTB) is occupied by one or more coding units (CUs). Each coding unit (CU) is associated with one or more arrays of data samples, generally referred to as ‘prediction units’ (PUs). Various arrangements of prediction units (PUs) in each coding unit (CU) are possible, with a requirement that the prediction units (PUs) do not overlap and that the entirety of the coding unit (CU) is occupied by the one or more prediction units (PUs). Such a requirement ensures that the prediction units (PUs) cover the entire frame area. The arrangement of the one or more prediction units (PUs) associated with a coding unit (CU) is referred to as a ‘partition mode’.

The video encoder 114 operates by outputting, from a multiplexer module 340, a prediction unit (PU) 382 in accordance with the partition mode of a coding unit (CU). A difference module 344 produces a ‘residual sample array’ 360. The residual sample array 360 is the difference between the prediction unit (PU) 382 and a corresponding 2D array of data samples from a coding unit (CU) of the coding tree block (CTB) of the frame data 310. The difference is calculated for corresponding samples at each location in the arrays. As differences may be positive or negative, the dynamic range of one difference sample is the bit-depth plus one bit.

The residual sample array 360 may be transformed into the frequency domain in a transform module 320. The residual sample array 360 from the difference module 344 is received by the transform module 320, which converts the residual sample array 360 from a spatial representation to a frequency domain representation by applying a ‘forward transform’. The transform module 320 creates transform coefficients, according to a transform having a specific precision. The coding unit (CU) is sub-divided into one or more transform units (TUs). The sub-division of the coding unit (CU) into one or more transform units (TUs) may be referred to as a ‘residual quad-tree’ or a ‘residual quad-tree (RQT)’ or a ‘transform tree’.

The quantiser control module 346 may test the bit-rate required in encoded bitstream 312 for various possible quantisation parameter values according to a ‘rate-distortion criterion’. The rate-distortion criterion is a measure of the acceptable trade-off between the bit-rate of the encoded bitstream 312, or a local region thereof, and distortion. Distortion is a measure of the difference between frames present in the frame buffer 332 and the captured frame data 310. Methods of measuring distortion include using a peak signal to noise ratio (PSNR) or sum of absolute differences (SAD) metric. In some arrangements of the video encoder 114, the rate-distortion criterion considers only the rate and distortion for the luma colour channel and thus the encoding decision is made based on characteristics of the luma channel Generally, the residual quad-tree (RQT) is shared between the luma and chroma colour channels, and the amount of chroma information is relatively small compared to luma, so considering luma only in the rate-distortion criterion may be appropriate.

A quantisation parameter 384 is output from the quantiser control module 346. The quantisation parameter may be fixed for a frame of video data, or may vary on a block by block basis as the frame is being encoded. Other methods for controlling the quantisation parameter 384 are also possible. The set of possible transform units (TUs) for a residual quad-tree is dependent on the available transform sizes and coding unit (CU) size. In one arrangement, the residual quad-tree results in a lower bit-rate in the encoded bitstream 312, thus achieving higher coding efficiency. A larger sized transform unit (TU) results in use of larger transforms for both the luma and chroma colour channels. Generally, larger transforms provide a more compact representation of a residual sample array with sample data (or ‘residual energy’) spread across the residual sample array. Smaller transforms generally provide a more compact representation of a residual sample array with residual energy localised to specific regions of the residual sample array compared to larger transforms. Thus, the many possible configurations of a residual quad-tree (RQT) provide a useful means for achieving high coding efficiency of the residual sample array 360 in the high efficiency video coding (HEVC) standard.

A transform control module 348 selects a transform size for use in encoding each leaf node of the residual quad-tree (RQT). For example, a variety of transform sizes (and hence residual quad-tree configurations or transform trees) may be tested and the transform tree resulting in the best trade-off from a rate-distortion criteria may be selected. A transform size 386 represents a size of a selected transform. The transform size 386 is encoded in the encoded bitstream 312 and provided to the transform module 320, the quantiser module 322, the dequantiser module 326 and the inverse transform module 328. The transform size 386 may be represented by the transform dimensions (e.g. 4×4, 8×8, 16×16 or 32×32), the transform size (e.g. 4, 8, 16 or 32), or the log 2 of the transform size (e.g. 2, 3, 4 or 5) interchangeably. In circumstances where the numeric value of a particular representation of a transform size is used (e.g. in an equation) conversion from any other representation of the transform size deemed necessary, shall be considered to implicitly occur in the following description.

The video encoder 114 may be configured to perform in a ‘transform quantisation bypass’ mode, where the transform module 320 and the quantisation module 322 are bypassed. In the transform quantisation bypass mode, the video encoder 114 provides a means to losslessly encode the frame data 310 in the encoded bitstream 312. Use of the transform quantisation bypass mode is controlled at the coding unit (CU) level, allowing portions of the frame data 310 to be losslessly encoded by the video encoder 114. The availability of the transform quantisation bypass mode is controlled via ‘high level syntax’, enabling signalling overhead of controlling transform quantisation bypass mode to be removed in cases where lossless encoding is not required in any portion of the frame data 310. High level syntax refers to syntax structures present in the encoded bitstream 312 that are generally encoded infrequently and are used to describe properties of the bitstream 312. For example, the high level syntax structures of the encoded bitstream 312 may be used to restrict or otherwise configure particular coding tools used in the video encoder 114 and the video decoder 134. Examples of high level syntax structures include ‘sequence parameter sets’, ‘picture parameter sets’ and ‘slice headers’.

For the high efficiency video coding (HEVC) standard, conversion of the residual sample array 360 to the frequency domain representation is implemented using a transform, such as a modified discrete cosine transform (DCT). In such transforms, the modification permits implementation using shifts and additions instead of multiplications. Such modifications enable reduced implementation complexity compared to a discrete cosine transform (DCT). In addition to the modified discrete cosine transform (DCT), a modified discrete sine transform (DST) may also be used in specific circumstances. Various sizes of the residual sample array 360 and the scaled transform coefficients 362 are possible, in accordance with supported transform sizes. In the high efficiency video coding (HEVC) standard, transforms are performed on 2D arrays of data samples having sizes, such as 32×32, 16×16, 8×8 and 4×4. Thus, a predetermined set of transform sizes are available to the video encoder 114. Moreover, the set of transform sizes may differ between the luma channel and the chroma channels.

Two-dimensional transforms are generally configured to be ‘separable’, enabling implementation as a first set of 1D transforms operating on the 2D array of data samples in one direction (e.g. on rows). The first set of 1D transforms is followed by a second set of 1D transform operating on the 2D array of data samples output from the first set of 1D transforms in the other direction (e.g. on columns). Transforms having the same width and height are generally referred to as ‘square transforms’. Additional transforms, having differing widths and heights may also be used and are generally referred to as ‘non-square transforms’. The row and column one-dimensional transforms may be combined into specific hardware or software modules, such as a 4×4 transform module or an 8×8 transform module.

Transforms having larger dimensions require larger amounts of circuitry to implement, even though such larger dimensioned transforms may be infrequently used. Accordingly, the high efficiency video coding (HEVC) standard defines a maximum transform size of 32×32 luma samples. Transforms may be applied to both the luma and chroma channels. Differences between the handling of luma and chroma channels with regard to transform units (TUs) exist. Each residual quad-tree occupies one coding unit (CU) and is defined as a quad-tree decomposition of the coding unit (CU) into a hierarchy including one transform unit (TU) at each leaf node of the residual quad-tree hierarchy. Each transform unit (TU) has dimensions corresponding to one of the supported transform sizes. Similarly to the coding tree block (CTB), it is necessary for the entirety of the coding unit (CU) to be occupied by one or more transform units (TUs). At each level of the residual quad-tree hierarchy a ‘coded block flag value’ signals possible presence of a transform in each colour channel. The signalling may indicate presence of a transform at the current hierarchy level (when no further splits are present), or that lower hierarchy levels may contain at least one transform among the resulting transform units (TUs). When the coded block flag value is zero, all residual coefficients at the present or lower hierarchy levels are known to be zero. In such a case, no transform is required to be performed for the corresponding colour channel of any transform units (TU) at the present hierarchical level or at lower hierarchical levels. When the coded block flag value is one, if the present region is not further sub-divided then the region contains a transform which requires at least one non-zero residual coefficient. If the present region is further sub-divided, a coded block flag value of one indicates that each resulting sub-divided region may include non-zero residual coefficients. In this manner, for each colour channel, zero or more transforms may cover a portion of the area of the coding unit (CU) varying from none up to the entirety of the coding unit (CU). Separate coded block flag values exist for each colour channel Each coded block flag value is not required to be encoded, as cases exist where there is only one possible coded block flag value.

The scaled transform coefficients 362 are input to the quantiser module 322 where data sample values thereof are scaled and quantised, according to a determined quantisation parameter 384, to produce transform coefficients 364. The transform coefficients 364 are an array of values having the same dimensions as the residual sample array 360. The transform coefficients 364 provide a frequency domain representation of the residual sample array 360 when a transform is applied. When the transform is skipped, the transform coefficients 364 provide a spatial domain representation of the residual sample array 360 (i.e. quantised by the quantiser module 322 but not transformed by the transform module 320). For the discrete cosine transform (DCT), the upper-left value of the transform coefficients 364 specifies a ‘DC’ value for the residual sample array 360 and is known as a ‘DC coefficient’. The DC coefficient is representative of the ‘average’ of the values of the residual sample array 360. Other values in the transform coefficients 364 specify ‘AC coefficients’ for the residual sample array 360. The scale and quantisation results in a loss of precision, dependent on the value of the determined quantisation parameter 384. A higher value of the determined quantisation parameter 384 results in coarser quantisation and hence greater information being lost from the scaled transform coefficients 362. The loss of information increases the compression achieved by the video encoder 114, as there is less information to encode. The increase in compression efficiency occurs at the expense of reducing the visual quality of output from the video decoder 134. For example, a reduction in the peak signal to noise ratio (PSNR) of the decoded frames 412 compared to the frame data 310. The determined quantisation parameter 384 may be adapted during encoding of each frame of the frame data 310. Alternatively, the determined quantisation parameter 384 may be fixed for a portion of the frame data 310. In one arrangement, the determined quantisation parameter 384 may be fixed for an entire frame of frame data 310. Other adaptations of the determined quantisation parameter 384 are also possible, such as quantising each of the scaled transform coefficients 362 with separate values.

The transform coefficients 364 and determined quantisation parameter 384 are taken as input to the dequantiser module 326. The dequantiser module 326 reverses the scaling performed by the quantiser module 322 to produce rescaled transform coefficients 366. The rescaled transform coefficients are rescaled versions of the transform coefficients 364. The transform coefficients 364, the determined quantisation parameter 384, the transform size 386 and the bit-depth 390 are also taken as input to an entropy encoder module 324. The entropy encoder module 324 encodes the values of the transform coefficients 364 in an encoded bitstream 312. The encoded bitstream 312 may also be referred to as a ‘video bitstream’. Due to a loss of precision (e.g. resulting from the operation of the quantiser module 322), the rescaled transform coefficients 366 are not identical to the original values in the scaled transform coefficients 362. The rescaled transform coefficients 366 from the dequantiser module 326 are then output to an inverse transform module 328.

The inverse transform module 328 performs an inverse transform from the frequency domain to the spatial domain to produce a spatial-domain representation 368 of the rescaled transform coefficients 366. The spatial-domain representation 368 is substantially identical to a spatial domain representation that is produced at the video decoder 134. The spatial-domain representation 368 is then input to a summation module 342.

A motion estimation module 338 produces motion vectors 374 by comparing the frame data 310 with previous frame data from one or more sets of frames stored in a frame buffer module 332, generally configured within the memory 206. The sets of frames are known as ‘reference pictures’ and are enumerated in ‘reference picture lists’. The motion vectors 374 are then input to a motion compensation module 334 which produces an inter-predicted prediction unit (PU) 376 by filtering data samples stored in the frame buffer module 332, taking into account a spatial offset derived from the motion vectors 374. Not illustrated in FIG. 3, the motion vectors 374 are also passed to the entropy encoder module 324 for encoding in the encoded bitstream 312. The motion vectors may be encoded as ‘motion vector differences’ (or ‘motion vector deltas’) representing differences between the motion vector for a current block and a predicted motion vector. The predicted motion vector may be determined from one or more spatially or temporally neighbouring blocks. The predicted motion vector may be used for a current block without encoding a motion vector difference. A coding unit (CU) having no motion vector difference or residual coefficients in the encoded bitstream 312 is referred to as a ‘skipped’ block.

The intra-frame prediction module 336 produces an intra-predicted prediction unit (PU) 378 using samples 370 obtained from the summation module 342. In particular, the intra-frame prediction module 336 uses samples from neighbouring blocks that have already been decoded to produce intra-predicted samples for the current prediction unit (PU). When a neighbouring block is not available (e.g. at a frame boundary) the neighbouring samples are considered as ‘not available’ for reference. In such cases, a default value may be used instead of the neighbouring sample values. Typically, the default value (or ‘half-tone’) is equal to half of the range implied by the bit-depth. For example, when the video encoder 114 is configured for a bit-depth of eight (8), the default value is 128. The summation module 342 sums the prediction unit (PU) 382 from the multiplexer module 340 and the spatial domain output of the multiplexer 382. The intra-frame prediction module 336 also produces an intra-prediction mode 380 which is sent to the entropy encoder 324 for encoding into the encoded bitstream 312.

An intra block copy module 350 tests various block vectors to produce a reference block for the prediction unit (PU) 382. The reference block includes a block of samples 370 obtained from the current coding tree block (CTB) and/or the previous coding tree block (CTB). The reference block does not include samples from any coding units (CUs) in the current coding tree block (CTB) that have not yet been decoded and hence are not available in the samples 370.

A block vector is a two-dimensional vector referencing a block within the pair of coding tree blocks (CTBs). The intra block copy module 350 may test every valid block vector by conducting a search using a nested loop. However, faster searching methods may be used by the intra block copy module 350 in producing the reference block. For example, the intra block copy module 350 may reduce the search complexity by searching for block vectors aligned horizontally or vertically to the current coding unit (CU). In another example, near-horizontal and near-vertical block vectors may also be searched by the intra block copy module 350 to produce a reference block. In another example, the intra block copy module 350 may test a spatially sparse set of block vectors and then perform a refined search in the neighbourhood of a selected one of the sparse block vectors to produce a final block vector.

Entropy coding a block vector has an associated cost, or rate. One method of entropy coding a block vector is to reuse the motion vector difference (i.e. ‘mvd_coding’) syntax structure. The motion vector difference syntax structure permits encoding of a two-dimensional signed vector and is thus suitable for a block vector. The motion vector difference syntax structure encodes smaller magnitude vectors more compactly than larger magnitude vectors. Consequently, in the rate measurement, a bias towards selecting nearby reference blocks may be introduced.

A given block vector results in a particular reference block having a particular distortion. Of the block vectors that are tested by the video encoder 114, the rate-distortion trade-off is applied to determine which block vector to apply for the intra block copy mode. An overall rate distortion trade-off may compare the result for the intra block copy mode with the result for other prediction methods, such as inter-prediction and intra-prediction.

Prediction units (PUs) may be generated using either an intra-prediction, an inter-prediction or an intra block copy method. Intra-prediction methods make use of data samples adjacent to the prediction unit (PU) that have previously been decoded (i.e., typically above and to the left of the prediction unit) in order to generate reference data samples within the prediction unit (PU). Various directions of intra-prediction are possible. In one arrangement, thirty three (33) directions of intra-prediction are possible. A ‘DC mode’ and a ‘planar mode’ may be supported, for a total of thirty five (35) possible intra-prediction modes.

Inter-prediction methods make use of a motion vector to refer to a block from a selected reference frame. With reference to FIG. 3, the motion estimation module 338 and motion compensation module 334 operate on motion vectors 374, having a precision of one eighth (⅛) of a luma sample, enabling precise modelling of motion between frames in the frame data 310. The decision on which of the intra-prediction, the inter-prediction or the intra block copy method to use may be made according to a rate-distortion trade-off. The rate-distortion trade-off is made between the desired bit-rate of the resulting encoded bitstream 312 and the amount of image quality distortion introduced by either the intra-prediction, inter-prediction or the intra block copy method. If intra-prediction is used, one intra-prediction mode is selected from the set of possible intra-prediction modes, also according to a rate-distortion trade-off. The multiplexer module 340 may select the intra-predicted reference samples 378 from the intra-frame prediction module 336, or the inter-predicted prediction unit (PU) 376 from the motion compensation block 334, or the reference block from the intra block copy module 350.

The summation module 342 produces a sum 370 that is input to a de-blocking filter module 330. The de-blocking filter module 330 performs filtering along block boundaries, producing de-blocked samples 372 that are written to the frame buffer module 332 configured within the memory 206. The frame buffer module 332 is a buffer with sufficient capacity to hold data from one or more past frames for future reference for inter-predicted prediction units (PUs).

For the high efficiency video coding (HEVC) standard, the encoded bitstream 312 produced by the entropy encoder 324 is delineated into network abstraction layer (NAL) units. Frames are encoded using one or more ‘slices’, with each slice including one or more coding tree blocks (CTBs). Two types of slice are defined, ‘independent slice segments’ and ‘dependent slice segments’. Generally, each slice of a frame is contained in one NAL unit. The entropy encoder 324 encodes the transform coefficients 364, the intra-prediction mode 380, the motion vectors (or motion vector differences) and other parameters, collectively referred to as ‘syntax elements’, into the encoded bitstream 312 by performing a context adaptive binary arithmetic coding (CABAC) algorithm. Syntax elements are grouped together into ‘syntax structures’. The groupings may contain recursion to describe hierarchical structures. In addition to ordinal values, such as an intra-prediction mode or integer values, such as a motion vector, syntax elements also include flags, such as to indicate a quad-tree split.

The video encoder 114 also divides a frame into one or more ‘tiles’. Each tile is a rectangular set of coding tree blocks (CTBs) that may be encoded and decoded independently, facilitating parallel implementations of the video encoder 114 and the video decoder 134. Within each tile, coding tree blocks (CTBs) are scanned in a raster order and a single core (or thread) implementation of the video encoder 114 or the video decoder 134 scans the tiles in raster scan order. To enable a parallel implementation of the video encoder 114 and the video decoder 134, intra-prediction of blocks along a tile boundary may not use samples from blocks in a neighbouring tile. As such, the neighbouring samples may be marked as not available for intra-prediction even though the sample values do exist.

Although the video decoder 134 of FIG. 4 is described with reference to a high efficiency video coding (HEVC) video decoding pipeline, other video codecs may also employ the processing stages of modules 420-436. The encoded video information may also be read from memory 206, the hard disk drive 210, a CD-ROM, a Blu-Ray™ disk or other computer readable storage medium. Alternatively the encoded video information may be received from an external source, such as a server connected to the communications network 220 or a radio-frequency receiver.

As seen in FIG. 4, received video data, such as the encoded bitstream 312, is input to the video decoder 134. The encoded bitstream 312 may be read from memory 206, the hard disk drive 210, a CD-ROM, a Blu-Ray™ disk or other computer readable storage medium. Alternatively the encoded bitstream 312 may be received from an external source such as a server connected to the communications network 220 or a radio-frequency receiver. The encoded bitstream 312 contains encoded syntax elements representing the captured frame data to be decoded.

The encoded bitstream 312 is input to an entropy decoder module 420 which extracts the syntax elements from the encoded bitstream 312 and passes the values of the syntax elements to other blocks in the video decoder 134. The entropy decoder module 420 applies the context adaptive binary arithmetic coding (CAB AC) algorithm to decode syntax elements from the encoded bitstream 312. The decoded syntax elements are used to reconstruct parameters within the video decoder 134. Parameters include zero or more residual data array 450 and motion vectors 452. Motion vector differences are decoded from the encoded bitstream 312 and the motion vectors 452 are derived from the decoded motion vector differences.

The parameters reconstructed within the video decoder 134 also include a prediction mode 454, a quantisation parameter 468, a transform size 470 and a bit-depth 472. The transform size 470 was encoded in the encoded bitstream 312 by the video encoder 114 according to the transform size 386. The bit-depth 472 was encoded in the encoded bitstream 312 by the video encoder 114 according to the bit-depth 390. The quantisation parameter 468 was encoded in the encoded bitstream 312 by the video encoder 114 according to the quantisation parameter 384. Thus, the transform size 470 is equal to the transform size 386, the bit-depth 472 is equal to the bit-depth 390 and the quantisation parameter 468 is equal to the quantisation parameter 384.

The residual data array 450 is passed to a dequantiser module 421, the motion vectors 452 are passed to a motion compensation module 434, and the prediction mode 454 is passed to an intra-frame prediction module 426 and to a multiplexer 428.

With reference to FIG. 4, the dequantiser module 421 performs inverse scaling on the residual data of the residual data array 450 to create reconstructed data 455 in the form of transform coefficients. The dequantiser module 421 outputs the reconstructed data 455 to an inverse transform module 422. The inverse transform module 422 applies an ‘inverse transform’ to convert the reconstructed data 455 (i.e., the transform coefficients) from a frequency domain representation to a spatial domain representation, outputting a residual sample array 456 via a multiplexer module 423. The inverse transform module 422 performs the same operation as the inverse transform module 328. The inverse transform module 422 is configured to perform inverse transforms sized in accordance with the transform size 470 having a bit-depth according to the bit-depth 472. The transforms performed by the inverse transform module 422 are selected from a predetermined set of transform sizes required to decode an encoded bitstream 312 that is compliant with the high efficiency video coding (HEVC) standard.

The motion compensation module 434 uses the motion vectors 452 from the entropy decoder module 420, combined with reference frame data 460 from a frame buffer block 432, configured within the memory 206, to produce an inter-predicted prediction unit (PU) 462 for a prediction unit (PU). The inter-predicted prediction unit (PU) 462 is a prediction of output decoded frame data based upon previously decoded frame data. When the prediction mode 454 indicates that the current prediction unit (PU) was coded using intra-prediction, the intra-frame prediction module 426 produces an intra-predicted prediction unit (PU) 464 for the prediction unit (PU). The intra-predicted prediction unit (PU) 464 is produced using data samples spatially neighbouring the prediction unit (PU) and a prediction direction also supplied by the prediction mode 454. The spatially neighbouring data samples are obtained from a sum 458, output from a summation module 424.

As seen in FIG. 4, an intra block copy module 436 of the video decoder 134 produces a block of reference samples, by copying an array of samples from the current and/or the previous coding tree blocks (CTBs). The offset of the reference samples is calculated by adding a block vector, decoded by the entropy decoder 420, to the location of the current coding unit (CU). The multiplexer module 428 selects the intra-predicted prediction unit (PU) 464 or the inter-predicted prediction unit (PU) 462 for a prediction unit (PU) 466 or a reference block from the intra block copy module 436, depending on the current prediction mode 454. The prediction unit (PU) 466, which is output from the multiplexer module 428, is added to the residual sample array 456 from the inverse scale and transform module 422 by the summation module 424 to produce sum 458. The sum 458 is then input to each of a de-blocking filter module 430, the intra-frame prediction module 426 and the intra block copy module 436. The de-blocking filter module 430 performs filtering along data block boundaries, such as transform unit (TU) boundaries, to smooth visible artefacts. The output of the de-blocking filter module 430 is written to the frame buffer module 432 configured within the memory 206. The frame buffer module 432 provides sufficient storage to hold one or more decoded frames for future reference. Decoded frames 412 are also output from the frame buffer module 432 to a display device, such as the display device 136 which may be in the form of the display device 214.

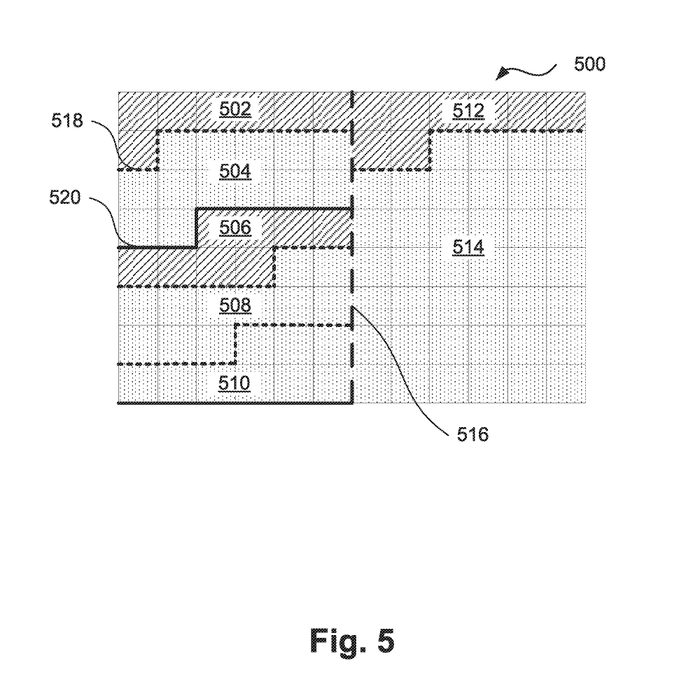

FIG. 5 is a schematic block diagram showing a frame 500 that is divided into two tiles and three slice segments as described below.

The frame 500 includes an array of coding tree blocks (CTBs), which are represented as grid cells in FIG. 5. The frame 500 is divided into two tiles which are separated by a dashed line 516 in FIG. 5. The three slices of the frame 500 include independent slice segments 502, 506 and 512 and dependent slice segments 504, 508, 510 and 514. Dependent slice segment 504 is dependent on independent slice segment 502. Dependent slice segments 508 and 510 are dependent on independent slice segment 506. Dependent slice segment 514 is dependent on independent slice segment 512.

The division of the frame 500 into slices is represented in FIG. 5 using thick lines, such as line 520. Each slice is divided into an independent slice segment and zero or more dependent slice segments as shown by dashed lines in FIG. 5, such as line 518. Accordingly, in the example of FIG. 5, one slice includes slice segments 502 and 504, one slice includes slice segments 506, 508 and 510 and one slice includes slice segments 512 and 514.

Scanning of coding tree blocks (CTBs) in the frame 500 is ordered such that the first tile is scanned in raster order followed by scanning the second tile in raster order. Intra-predicted prediction units (PUs) may be aligned to either or both of the top edge or the left edge of a coding tree block (CTB). In such cases the neighbouring samples required for intra-prediction may be located in an adjacent coding tree block (CTB). The adjacent coding tree block (CTB) may belong to a different tile or a different slice. In such cases, the neighbouring samples are not accessed. Instead, a default value is used. The default value may be derived from other neighbouring samples that are available. Generally, for each unavailable neighbouring sample, the nearest available neighbouring sample value is used. Alternatively, the default value may be set equal to the half-tone value implied by the bit-depth, i.e. two to the power of the result of subtracting one from the bit depth.

The arrangement of tiles in the frame 500 as shown in FIG. 5 is beneficial for parallel processing. For example, the video encoder 114 may include multiple instances of the entropy encoder 324 and the video decoder 134 may include multiple instances of the entropy decoder 420. Each tile may be concurrently processed by a separate instance of the entropy encoder 324 and the entropy decoder 420.

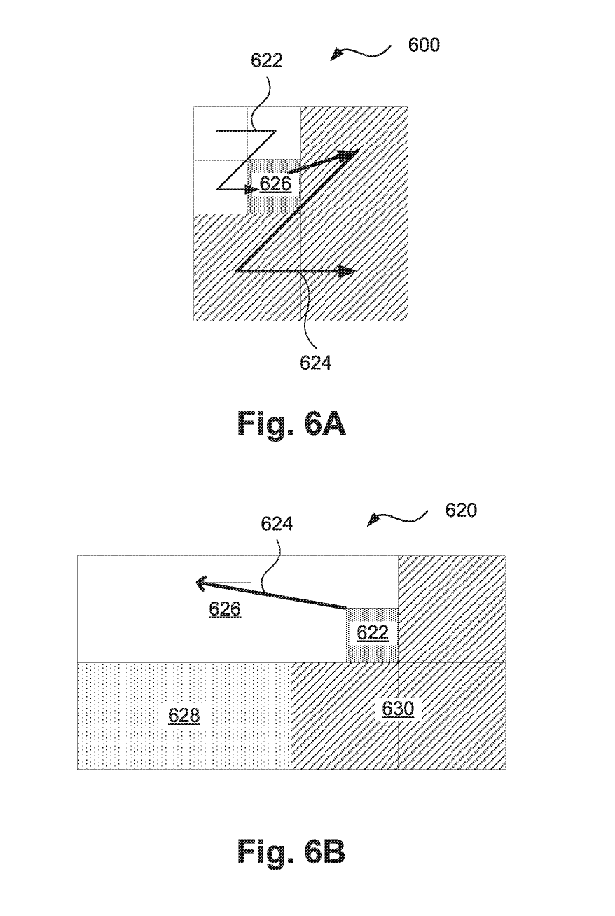

FIG. 6A is a schematic block diagram showing an example ‘Z-scan’ order of scanning regions within a coding tree block (CTB) 600. At each level of the hierarchical decomposition of the coding tree block (CTB) 600, a scan resembling a ‘Z’ is performed, i.e. scanning the upper two regions from left to right, and then scanning the lower two regions from left to right. The scan is applied recursively in a depth-first manner. For example, if a region at a current hierarchy level is sub-divided into further regions at a lower hierarchy level, a Z-scan is applied within the lower hierarchy level prior to proceeding to the next region at the current hierarchy level. Regions of a coding tree block (CTB) that are not further sub-divided contain a coding unit (CU). In the example of FIG. 6A, the four coding units (CUs) in the top-left of the coding tree block (CTB) 600 are scanned as in a Z-scan order 622, reaching a coding unit (CU) 626 that is currently being processed in the example of FIG. 6A. The remainder of the coding tree block (CTB) 600 will be scanned according to Z-scan order 624. Samples from previously decoded coding units (CUs) in the coding tree block (CTB) 600 are available for intra-prediction. The samples from the coding units (CUs) that have not yet been decoded by the video decoder 134, as represented by diagonal hatching in FIG. 6A, are not available for intra-prediction. As such, the video encoder 114 also treats the samples that have not yet been decoded as not being available for intra-prediction.

FIG. 6B is a schematic block diagram showing an example block vector 624 referencing a block of samples in a neighbouring coding tree block (CTB) relative to a coding unit (CU) within a current coding tree block (CTB). Referencing within the neighbouring coding tree block (CTB) is restricted by the vertical position of the coding unit (CU) in the current coding tree block (CTB). In the example of FIG. 6B, a frame portion 620 includes two coding tree blocks (CTBs) belonging to the same tile and the same slice. The two coding tree blocks (CTBs) are a current coding tree block (CTB) (i.e., right half of the frame portion 620) and a previous coding tree block (CTB) (i.e., left half of the frame portion 620). Intra block copy prediction is applied to coding unit (CU) 622 in the example of FIG. 6B. Block vector 624 specifies the location of a reference block 626 relative to the location of the coding unit (CU) 622. The reference block 626 is obtained from samples prior to in-loop filtering (e.g. deblocking) being performed on the samples. Therefore, buffering of samples of the current coding tree block (CTB) and the previous coding tree block (CTB) prior to deblocking is required, in order to provide samples at all possible locations of a reference block.

The use of reference samples prior to in-loop filtering being performed on the reference samples is consistent with the intra-prediction process. In the intra-prediction process neighbouring samples are necessarily used prior to deblocking, as the deblocking process introduces a dependency on samples within the current coding unit (CU), that are not yet available. The block vector 624 includes two positive integer values (x,y) that specify the location of the reference block 626 as a leftward (horizontal) displacement and an upward (vertical) displacement, relative to the location of the coding unit (CU) 622. As such, it is not possible to specify a block vector that would result in a dependency on the portion of the current coding tree block (CTB) that is yet to be decoded by the video decoder 134 (e.g. 630). For example, given the position of the coding unit (CU) 622 in the upper-left quadrant of the current coding tree block (CTB), the described co-ordinate scheme prevents use of the lower half (e.g. 630) of the current coding tree block (CTB) for the reference block. Preventing use of the lower half (e.g. 630) of the current coding tree block (CTB) also prevents use of the lower half (e.g. 628) of the previous coding tree block (CTB).

The block vector 624 specifies the top-left sample location of the reference block 626 relative to the top-left sample location of the coding unit (CU) 622. As such, block vectors that would result in overlap of a reference block and the current coding unit (CU) are prohibited. For example, with a coding unit (CU) size of 16×16, block vectors such as (−16, 0), (0, −16), (−17, −18) are permitted whereas block vectors such as (0,0), (−15, −15), (−8, 0) are prohibited. In general, block vectors where both the horizontal and vertical displacements are less than the width and height of the coding unit (CU) are prohibited. Additionally, restrictions on the reference block location in the previous coding tree block (CTB) result in a reduction in the available coding efficiency improvement provided by the intra block copy module 350. As the entirety of the previous coding tree block (CTB) is available, relaxing the restriction to enable reference block locations anywhere on the previous coding tree block (CTB) improves coding efficiency.

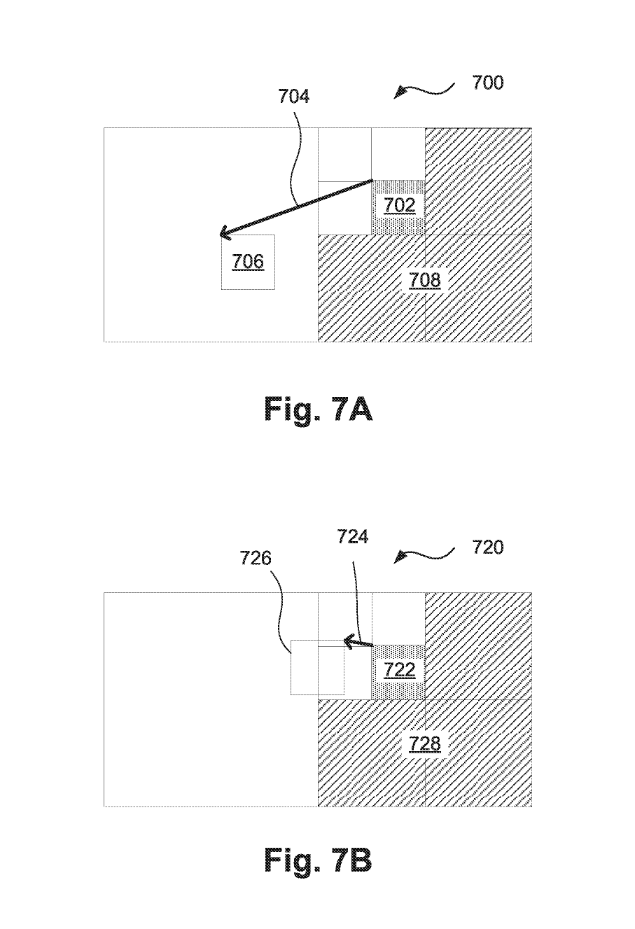

FIG. 7A is a schematic block diagram showing an example block vector 704 referencing a block of samples in a neighbouring coding tree block (CTB) relative to a coding unit (CU) within a current coding tree block (CTB). Referencing within the neighbouring coding tree block (CTB) is unrestricted by the vertical position of the coding unit (CU) in the current coding tree block (CTB). As with FIG. 6B, example frame portion 700 shown in FIG. 7A includes a current coding tree block (CTB) and a previous coding tree block (CTB). Intra block copy prediction is applied to a coding unit (CU) 702. Block vector 704 specifies the location of a reference block 706, within the frame portion 700. As with FIG. 6B, the block vector 706 is prohibited from locating the reference block if the reference block would overlap any portion of the current coding tree block (CTB) that has not yet been decoded (e.g. 708). The block vector 706 is also prohibited from locating the reference block if the reference block would overlap the current coding unit (CU) 702. In contrast to FIG. 6B, the block vector 704 may specify a positive and a negative displacement in both the x and y axes.

FIG. 7B is a schematic block diagram showing an example block vector 724 referencing a block of samples spanning both a current coding tree block (CTB) and a neighbouring coding tree block (CTB). The block vector referencing in the example of FIG. 7B is relative to the top-right corner of the block of reference samples. As with FIG. 7A, frame portion 720 includes two coding tree blocks (CTBs). Block vector 724 specifies the location of a reference block 726 relative to the coding unit (CU) 722 that is currently being processed in the example of FIG. 7B. As with FIG. 7A, the reference block 726 may not overlap the coding unit (CU) 722 or the portion of the current coding tree block (CTB) that is yet to be decoded (e.g. 728). In contrast to FIG. 7A, the block vector 724 specifies the location of the top-right of the reference block 726. For example, a block vector of (0, 0) results in a reference block adjacent to the coding unit (CU). A variable ‘cu_size’ may be defined, representing the width or height of the coding unit (CU) 722. In such arrangements, the location of the reference block 726 may be specified by the vector addition of the location of the coding unit (CU) 722, the block vector 724 and an offset vector, defined as (−cu_size, 0). Other offset vectors are also possible, e.g. (0, −cu_size) or (−cu_size, −cu_size).

FIG. 8A is a schematic block diagram showing an example block vector 804 referencing a block of samples spanning both a current coding tree block (CTB) and a neighbouring coding tree block (CTB) 810 within a frame portion 800. The coding tree block (CTB) 810 is marked as being unavailable (e.g. due to belonging to a different tile to the current coding tree block (CTB)). As such, reference block 806 is restricted to only use samples within the current coding tree block (CTB). Block vector 804 specifies the location of the reference block 806 relative to the location of coding unit (CU) 802. Block vector 804 specifies a reference block that overlaps with the coding tree block (CTB) 810. As the samples from the coding tree block (CTB) 810 are marked as not available, alternative values are used to populate the coding tree block (CTB) 810 portion of the reference block 806. In one arrangement, a default value, such as the default value that is used when neighbouring samples are not available for intra-prediction, may be used to populate the overlapping portion of the reference block 806. For example, when the video encoder 114 is configured for a bit-depth of eight (8), the default value used is one hundred and twenty eight (128) and when configured for a bit-depth of ten (10), the default value used is five hundred and twelve (512). Other methods of populating the overlapping portion of the reference block 806 are also possible. For example, in one arrangement of the video encoder 114, the sample values at the edge of the non-overlapping portion (i.e. within the current coding tree block (CTB)) may be used to populate the overlapping portion of the reference block 806. The sample values at the edge of the non-overlapping portion may be used by clipping the co-ordinates of samples within the reference block 806 according to the current coding tree block (CTB), thus prohibiting access to the coding tree block (CTB) 810.

FIG. 8B is a schematic block diagram showing an example adjusted block vector 824 referencing a block of samples within a current coding tree block (CTB). In the example of FIG. 8B, the adjusted block vector 824 is not referencing any samples from a neighbouring coding tree block (CTB) 830 that is marked as being unavailable. Frame portion 820 includes two coding tree blocks (CTBs) from which a reference block 826 is obtained. The reference block 826 may not use samples from the coding tree block (CTB) 830 for reference, as the coding tree block (CTB) 830 is marked as not available for reference (e.g. due to belong to a different tile). In the example of FIG. 8B, a clipped block vector 824 specifies the location of the reference block 826 relative to coding unit (CU) 822. In one arrangement of the video encoder 114 and the video decoder 134, the clipped block vector 824 may be derived from a block vector present in the encoded bitstream 312, e.g. equal to the block vector 804 of FIG. 8A. In an arrangement which derives the clipped block vector 824 from a block vector present in the encoded bitstream 312, a clipping operation may be used to prevent the reference block 826 from overlapping the coding tree block (CTB) 830 that is not available.

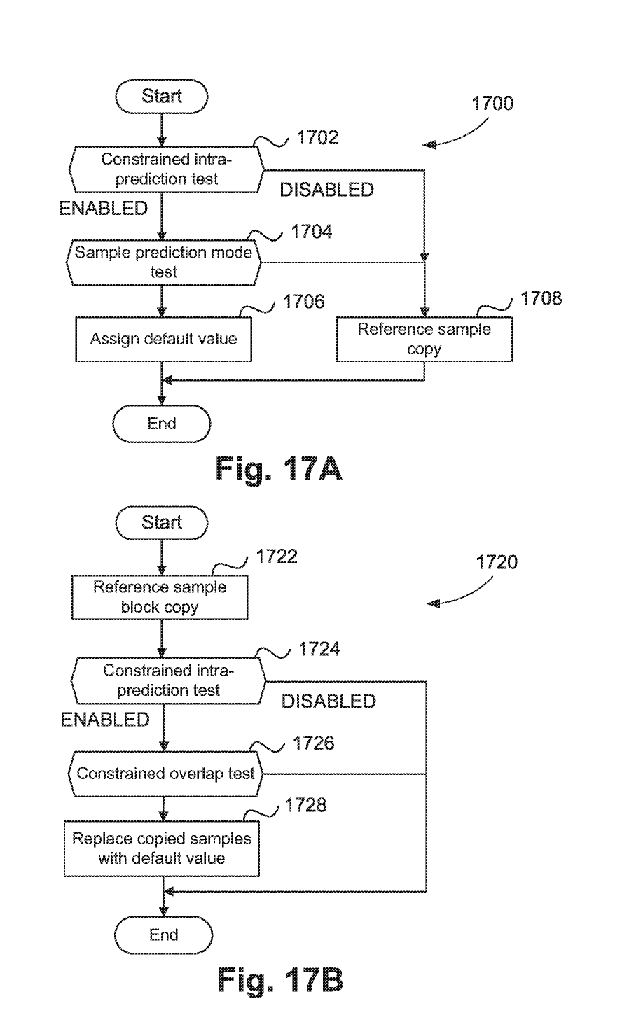

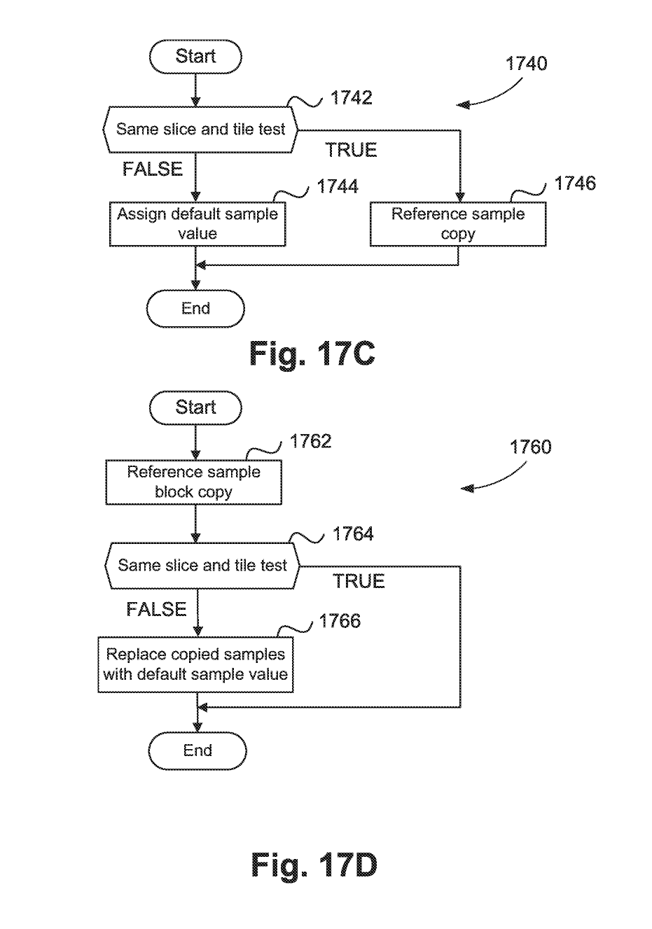

FIG. 8C is a schematic block diagram showing an example block vector 844 referencing a block 846 of samples, where some of the referenced samples were decoded using inter-prediction. Frame portion 840 includes two coding tree blocks (CTBs) from which the reference block 846 is obtained. In the example of FIG. 8C, the video encoder 114 and the video decoder 134 are configured to use ‘constrained intra-prediction’. Constrained intra-prediction is a mode whereby the neighbouring samples for the intra-prediction process may only be obtained from other intra-predicted (or intra block copied) coding units (CUs). As such, coding units (CUs) that were predicted using inter-prediction may not be used to provide neighbouring samples for intra-prediction when constrained intra-prediction mode is enabled. Inter-predicted coding units (CUs) depend on previous frames for reference. In some cases a previous frame may not be available at the video decoder 134 (e.g. due to a transmission error in the communications channel 120). In cases where a previous frame is available at the video decoder 134, some other information is populated into the inter-predicted coding unit (CU), as the intended reference block is not available. Constrained intra-prediction improves error resilience by preventing such erroneous data resulting from missing frames from propagating into intra-predicted coding units (CUs). Inter-predicted coding units (CUs) are thus considered not available for reference by intra-predicted coding units (CUs) when constrained intra-prediction is enabled. The intra block copy mode has a similar constraint by considering inter-predicted coding units (CUs) as not available for reference. A method 1700 of generating a reference sample block for a coding unit (CU) will be described below with reference to FIG. 17A.

A method 1000 of encoding a coding unit (CU) syntax structure (e.g. 902, see FIG. 9) for a coding unit (CU) using the intra block copy mode, is described below with reference to FIG. 10. Arrangements of the video encoder 114 using the method 1000 may prohibit block vectors that result in accessing any samples from inter-predicted coding units (CUs) for the intra block copy mode. In an arrangement using the method 1000, a normative restriction may be used, where the normative restriction states that no intra block vector may be present in the encoded bitstream 312 that would result in a reference block that requires samples from an inter-predicted block. In the arrangement using the method 1000, block search step 1002 does not perform searching of such block vectors that would result in an non-conforming bitstream. The video decoder 134 may behave in an undefined manner if this situation were to occur, because a bitstream that would result in a reference block that requires samples from an inter-predicted block would be a ‘non-conforming’ bitstream and decoders are not required to decode such bitstreams. Block vector 846 of FIG. 8C is an example of a block vector that would result in a non-conforming bitstream.

The video encoder 114 is configured so as not to produce a non-conforming bitstream. As such, arrangements of the video encoder 114 may include logic in the intra block copy module 350 to prevent searching such non-conforming block vectors. In one arrangement of the video encoder 114, the intra block copy module 350 produces many different block vectors to test (in a rate-distortion sense). Testing of any block vector that would result in a non-conforming bitstream is aborted.

Alternatively, in one arrangement of the video encoder 114, the default sample value may be used to provide sample values for any portion of a reference block that overlaps with inter-predicted coding units (CUs). In the example of FIG. 8C, coding unit (CU) 848 is an inter-predicted coding unit (CU) and constrained intra-prediction is used by the video encoder 114 to process the coding unit (CU) 848. Thus, the portion of the reference block 846 that overlaps with the coding unit (CU) 848 uses default sample values, instead of using sample values obtained from the coding unit (CU) 848. With a smallest coding unit (SCU) size of 8×8, the prediction mode of the coding tree block (CTB) requires an 8×8 array of flags to indicate which coding units (CUs) were inter-predicted. In such an arrangement, intra block copy step 1018 and intra block copy step 1140 is modified to populate the overlapping portion (i.e. overlapping with an inter-predicted coding unit (CU)) with default sample values.

FIG. 8D is a schematic block diagram showing an example block vector 864 referencing a block of samples where reference block 866 includes samples within the current coding unit (CU) 862. A frame portion 860 includes two coding tree blocks (CTBs) from which the reference block 866 is obtained. As the samples within the current coding unit (CU) have not yet been determined, the samples within the current coding unit (CU) cannot be used as part of the reference block 866.

In one arrangement a default sample value may be provided in place of an unavailable sample value. The default sample value may be derived in a similar manner to the default sample value for intra-prediction when neighbouring samples are marked as not available for reference. In such an arrangement, the intra block copy step 1018 and the intra block copy step 1140 is modified to populate the overlapping portion (i.e. overlapping with the current coding unit (CU)) with default sample values. FIG. 9 is a schematic block diagram showing a coding unit (CU) syntax structure 902 within a portion 900 of the bitstream 312. The encoded bitstream 312 includes sequences of syntax elements, divided for example into slices, frames, dependent slice segments, independent slice segments or tiles. Syntax elements are organised into hierarchical ‘syntax structures’. One such syntax structure is the coding unit (CU) syntax structure 902. An instance of a coding unit (CU) syntax structure exists for each coding unit (CU) in a slice, tile or frame. The context of an instance of a coding unit (CU) syntax structure may prevent particular syntax elements from being present. For example, syntax elements relating to inter-prediction are not present in a coding unit (CU) syntax structure within a slice that is indicated to only use intra-prediction. The coding unit (CU) syntax structure 902 may be used in cases where the intra block copy function is available and in use.

As shown in FIG. 9, the coding unit (CU) syntax structure 902 includes other syntax elements and syntax structures (e.g. 904 to 918). A transquant bypass flag 904 (‘cutransquant_bypass_flag’) signals the use of ‘transform quantisation bypass’ mode for the coding unit (CU). The transquant bypass flag 904 is present if a ‘transquant_bypass_enabled_flag’, present in the high level syntax was true. The transquant bypass flag 904 is signalled independently of whether intra block copy is enabled, thus intra block copy may be applied to both lossless and lossy coding cases.

A skip flag 906 (‘cu_skip_flag’) is present in the encoded bitstream 312 for coding units (CUs) in slices that may be inter-prediction. The skip flag 906 signals that the coding unit (CU) includes an inter-predicted prediction units (PUs) and that no residual or motion vector difference is present in the encoded bitstream 312 for the prediction unit (PU) associated with this coding unit (CU). In this case, a prediction unit (PU) syntax structure is included and may result in one syntax element being included, to specify a neighbouring prediction unit (PU) from which the motion vector for the coding unit (CU) will be derived. When the skip flag 906 indicates the use of skipping the coding unit (CU), no further syntax elements are included by the coding unit (CU) syntax structure. As such, the skip flag 906 provides an efficient means to represent coding units (CUs) in the encoded bitstream 312. The skip flag 906 is usable in cases where no residual is required (i.e. where the inter-predicted reference block is very close or identical to the corresponding portion of the frame data 310). When the coding unit (CU) is not skipped, additional syntax elements are introduced by the coding unit (CU) syntax structure 902 to further specify the configuration of the coding unit (CU).

A prediction mode flag 908 (‘PMF’ in FIG. 9, or ‘pred_mode_flag’) is used to signal the use of either intra-prediction or inter-prediction for the coding unit (CU). For coding units (CUs) in slices where inter-prediction is not available, the prediction mode flag 908 is not signalled. If the prediction mode flag 908 indicates that the coding unit (CU) is configured to use intra-prediction and an intra block copy enabled flag is true, an intra block copy flag 910 (or ‘intra_bc_flag’) is present in the encoded bitstream 312.

The intra block copy flag 910 signals the use of the intra block copy mode for the coding unit (CU). The intra block copy flag 910 is used for indicating that current samples are based on previously decoded samples of a current frame.

The intra block copy enabled flag is encoded as high level syntax. A partition mode 912 syntax element is present in the encoded bitstream 312 if the coding unit (CU) is not using the intra block copy mode and either (or both) the prediction mode flag indicates the use of inter-prediction for the coding unit (CU) or the coding unit (CU) size is equal to the smallest coding unit (SCU). The partition mode 912 indicates a division of the coding unit (CU) into one or more prediction units (PUs). Where multiple prediction units (PUs) are contained in the coding unit (CU) the partition mode 912 also indicates the geometric arrangement of the prediction units (PUs) within the coding unit (CU). For example, a coding unit (CU) may contain two rectangular prediction units (PUs), by a horizontal division (e.g. ‘PART_2N×N’) or a vertical division (e.g. PART_N×2N′) of the coding unit (CU), which is specified by the partition mode 912. If a single prediction unit (PU) occupies the entire coding unit (CU) the partition mode is ‘PART_2N×2N’. The intra block copy mode is applied to the entire coding unit (CU) and thus the partition mode is not signalled and is implied to be ‘PART_2N×2N’. If the intra block copy mode is in use, a block vector is present in the encoded bitstream 312, encoded as a block vector 914.

The block vector 914 specifies the location of a reference block relative to the coding unit (CU). Alternatively, the block vector 914 may specify the location of the reference block relative to some other entity, such as the coding tree block (CTB) in which the coding unit (CU) is contained. The block vector 914 includes a horizontal and a vertical offset and may reuse a pre-existing syntax structure. For example, a ‘motion vector difference’ syntax structure may be used to encode the horizontal and vertical offsets of the block vector in the encoded bitstream 312.

A root coded block flag 916 (or ‘rqt_root_cbf’) signals the presence of residual data within the coding unit (CU). If the flag 916 has a value of zero, no residual data is present in the coding unit (CU). If the flag 916 has a value of one, there is at least one significant residual coefficient in the coding unit (CU) and hence a residual quad-tree (RQT) exists in the coding unit (CU). In such cases, a transform tree 918 syntax structure encodes the uppermost hierarchical level of the residual quad-tree (RQT) in the encoded bitstream 312. Additional instances of transform tree syntax structures and transform unit syntax structures are present in the transform tree 918 syntax structure, in accordance with the residual quad-tree hierarchy of the coding unit (CU).

The method 1000 of encoding a coding unit (CU) syntax structure (e.g. 902) for a coding unit (CU) using the intra block copy mode, will now be described. The method 1000 may be implemented as one or more of the software code modules implementing the video encoder 114, which are resident in the hard disk drive 210 and are controlled in their execution by the processor 205. The method 1000 may be used by the video encoder 114 to encode the coding unit (CU) syntax structure 900 of FIG. 9 into the encoded bitstream 312.

The method 1000 begins at a block search step 1002, where the processor 205 is used for searching for a reference block within the current and/or previous coding tree block (CTB). One or more block vectors are tested at step 1002 and a match between the coding tree block (CTB) and the reconstructed sample data is measured by measuring distortion. Also at step 1002, the cost of coding the block vector in the encoded bitstream 312 is measured based on the bit-rate of the encoded bitstream 312. Of the block vectors tested, a block vector by the video encoder 114 is selected for use by the video encoder 114 based on the determined bit-rate and distortion. The selected block vector may be stored in the memory 206. As described above, any suitable search algorithm may be used for selecting the block vector at step 1002. A full search of every possible block vector may be performed. However, the complexity of performing a full search is generally unacceptable, for example, for real-time implementations of the video encoder 114. Other search methods may be used, such as searching for reference blocks which are horizontal or vertical (or near-horizontal and near-vertical) to the current coding unit (CU).

At an encode coding unit transquant bypass flag step 1004, the entropy encoder 320, under execution of the processor 205, encodes a coding unit transquant bypass flag (e.g. 904) into the encoded bitstream 312 which may be stored in the memory 206. The transquant bypass flag has a value of one when lossless coding of the coding unit (CU) is being performed and a value of zero when lossy coding of the coding unit (CU) is being performed.

Then at an encode coding unit skip flag step 1006, the entropy encoder 320, under execution of the processor 205, encodes a skip flag (e.g. 906) into the encoded bitstream 312. The skip flag signals if coding of the motion vector difference and residual for the coding unit (CU) will be skipped. If coding of the motion vector difference and residual for the coding unit (CU) is skipped, a motion vector for the coding unit (CU) is derived from previous motion vectors (e.g. from blocks adjacent to the current coding unit (CU)). Also, no residual is present in the encoded bitstream for skipped coding units (CUs).

At an encode pred_mode_flag step 1008, the entropy encoder 320, under execution of the processor 205, encodes a prediction mode (e.g. 908) into a prediction mode flag (i.e., pred_mode_flag) for the coding unit (CU) and stores the prediction mode flag in the memory 206. Generally, the pred_mode_flag indicates one of intra-prediction mode (i.e., ‘MODE_INTRA’) and inter-prediction mode (i.e., ‘MODE_INTER’) for the coding unit (CU). When the intra block copy mode is in use, the pred_mode_flag may be set to ‘MODE_INTRA’, although the prediction mode of the coding unit (CU) may be ‘MODE_INTRABC’. Then at a test prediction mode step 1009, the processor 205 tests the prediction mode for the coding unit (CU). If the prediction mode is inter-prediction, control passes to an encode mvd_coding step 1012. In this case, the intra_bc_flag is not encoded in the encoded bitstream 312, resulting in improved coding efficiency. Otherwise, control passes to an encode intra_bc_flag step 1010. At the encode intra_bc_flag step 1010, the entropy encoder 320, under execution of the processor 205, encodes an intra block copy flag (i.e., intra_bc_flag) (e.g. 910) into the encoded bitstream 312.

At the encode mvd_coding step 1012, the entropy encoder 320, under execution of the processor 205, encodes a block vector into the encoded bitstream 312 using the motion vector difference (i.e., ‘mvd_coding’) syntax structure which is also used for coding motion vector differences. Then at an encode root cbf step 1014, the entropy encoder 320, under execution of the processor 205, encodes a root coded block flag (i.e., root_cbf flag) into the encoded bitstream 312. The root_cbf flag signals the presence of at least one transform (i.e. having at least one significant residual coefficient) in the residual quad-tree (RQT) of the coding unit (CU).

Then at an encode transform tree step 1016, the entropy encoder 320 under execution of the processor 205 encodes the transform tree (i.e., the residual quad-tree (RQT)) for the coding unit (CU) depending on the root coded block flag. Step 1016 is performed if the root coded block flag (i.e., root_cbf flag) indicated the presence of at least one transform in the residual quad-tree (RQT).

At an intra block copy step 1018, the reference block is produced using the block vector selected at step 1002. The reference block is produced by copying an array of samples. The array of samples is of equal size to the coding unit (CU) size. The location of the reference sample array is relative to the current coding unit (CU), offset according to the block vector. The reference samples are obtained prior to in-loop filtering, and hence are obtained from the samples 370. The reference block produced at step 1018 may be stored in the memory 206 by the processor 205.

The method 1000 concludes at a reconstruction step 1020, where the summation module 342 adds the reference block produced at step 1018 to the residual to determine a reconstructed block (i.e., as part of the samples 370). The reference block is selected by the multiplexor module 340, under execution of the processor 205, as the intra block copy mode in use for the current coding unit (CU).

FIG. 11 is a schematic flow diagram showing a method 1100 of decoding the coding unit (CU) syntax structure 902 of FIG. 9 from the encoded bitstream 312. The method 1000 may be implemented as one or more of the software code modules implementing the video decoder 134, which are resident in the hard disk drive 210 and are controlled in their execution by the processor 205. The method 1100 may be performed by the video decoder 134, for example, when the video decoder 134 is parsing the syntax elements associated with a coding unit (CU).

The method 1100 tests variables having values that may have previously been derived from decoding a syntax element. In cases where no syntax element was decoded, one of the variables generally has a default value indicating a ‘disabled’ state. The method 1100 begins at a transquant bypass enabled test step 1102, where the processor 205 is used to test whether the transquant bypass mode is available to the coding unit (CU), by checking a previously decoded flag value (e.g. ‘transquant_bypass_enabled_flag’). If transquant bypass mode is available, control passes to a decode transquant_bypass_flag (e.g. ‘cutransquant_bypass_flag’) step 1104. Otherwise, control passes to a slice type test step 1106 and transquant bypass mode is implied to not be used.

At the decode transquant_bypass_flag step 1104, the entropy decoder module 420, under execution of the processor 205, decodes a flag (i.e., ‘cutransquant_bypass_flag’) from the encoded bitstream 312. The cu_transquant_bypass_{—} flag indicates if the coding unit (CU) uses the transquant bypass mode. As such, the cu_transquant_bypass_{—} flag enables the portion of the frame data 310 collocated with the coding unit (CU) to be losslessly represented.

At the slice type test step 1106, the processor 205 is used to determine if the slice within which the coding unit (CU) resides supports intra-prediction only (i.e. ‘slice_type==I’) or supports both intra-prediction and inter-prediction (i.e. ‘slice_type !=I’). If intra-prediction is the only available prediction mechanism, control passes to a cu_skip_flag test step 1110. Otherwise, control passes to a decode cu_skip_flag step 1108.

At the decode cu_skip_flag step 1108, the entropy decoder module 420, under execution of the processor 205, decodes a skip flag (‘cu_skip_flag’) from the encoded bitstream 312. The skip flag indicates if the coding unit (CU) is coded using a ‘skip mode’. In the ‘skip mode’, no motion vector difference or residual information is present in the encoded bitstream 312.

Then at the cu_skip_flag test step 1110, the processor 205 is used to test the value of the skip flag, cu_skip_flag. If the skip flag is true, control passes to a prediction unit step 1112. Otherwise control passes to a slice type test 1114.

At a prediction unit step 1112, the coding unit (CU) is configured by the processor 205 to use a ‘skip mode’. In the skip mode, motion vector difference and residual information is not decoded from the encoded bitstream 312. A motion vector is derived from the motion vectors of one or more neighbouring blocks. From the motion vector, a block of reference samples is produced by the motion compensation module 434. As there is no residual information for this coding unit (CU), the dequantiser module 421 and the inverse transform module 422 are inactive. The reference samples are deblocked by the deblocker module 430 and the resulting samples are stored in the frame buffer module 432. At the slice type test step 1114, the processor 205 is used to determine if the slice within which the coding unit (CU) resides supports intra-prediction only (i.e. ‘slice_type==I’) or supports both intra-prediction and inter-prediction (i.e. ‘slice_type !=I’). If intra-prediction is the only available prediction mechanism, control passes to a prediction mode test step 1117. Otherwise, control passes to a decode prediction mode flag step 1116.

At the prediction mode flag step 1116, the entropy decoder 420, under execution of the processor 205, decodes a prediction mode flag from the encoded bitstream 312 for use in determining a prediction mode for the coding unit (CU). The prediction mode flag indicates if the coding unit (CU) uses intra-prediction (i.e. ‘MODE_INTRA’) or inter-prediction (i.e. ‘MODE_INTER’). At the prediction mode test step 1117, the processor 205 is used to determine if the prediction mode of the coding unit (CU) is intra-prediction (i.e. ‘MODE_INTRA’). If the prediction mode of the coding unit (CU) is intra-prediction (i.e. ‘MODE_INTRA’), control passes to an intra_bc_enabled_flag test step 1118. Otherwise, control passes to an intra_bc_flag test step 1122.

At the intra_bc_enabled_flag test step 1118, the processor 205 is used to determine if the intra block copy mode is available for use in the coding unit (CU) by checking a flag value (e.g. ‘intra_block_copy_enabled_flag’ from a sequence parameter set). The flag value checked at step 1118 was previously decoded from the encoded bitstream 312 by the entropy decoder module 420 as part of the ‘high level syntax’. If the intra block copy mode is available, control passes to a decode intra_bc_flag step 1120. Otherwise control passes to the intra_bc_flag test step 1122.

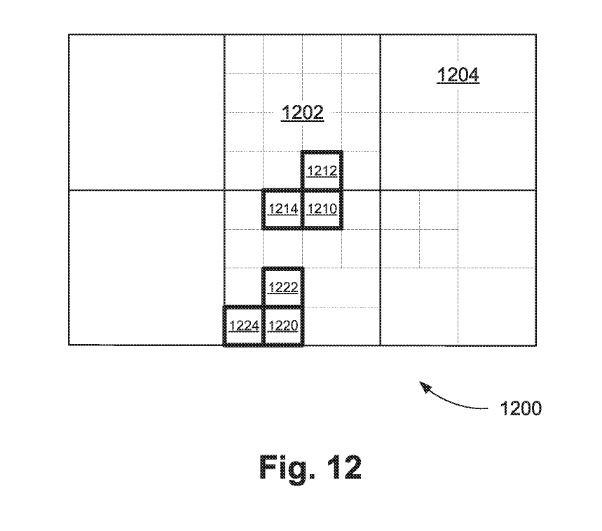

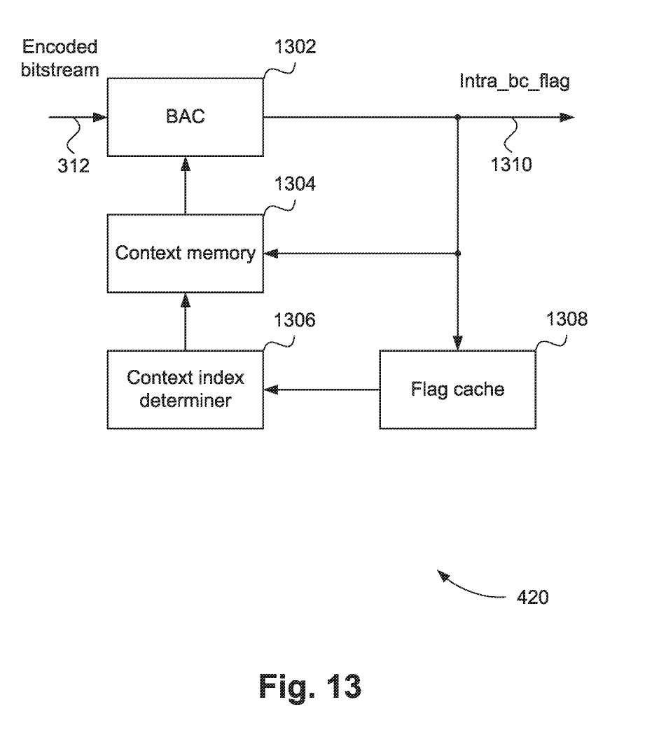

Then at the decode intra_bc_flag step 1120, the entropy decoder 420, under execution of the processor 205, is used for decoding a flag (e.g. ‘intra_bc_flag’) from the encoded bitstream 312 that signals the use of the intra block copy mode for the coding unit (CU). The intra block copy flag (i.e., ‘intra_bc_flag’) is decoded from the encoded bitstream 312 if the determined prediction mode is intra-prediction. The operation of the entropy decoder 420 when performing the decode intra_bc_flag step 1120 will be described further below with reference to FIGS. 12 and 13.

At the intra_bc_flag test step 1122, the processor 205 is used to test the value of the intra_bc_flag. If the intra_bc_flag is set to true, control passes to a partition mode coded test step 1124. Otherwise, control passes to a cu_type test step 1128.

Then at the partition mode coded test step 1124, conditions under which the ‘part_mode’ syntax element is present in the encoded bitstream 312 are tested under execution of the processor 205. If the coding unit (CU) prediction mode is not intra-prediction (i.e. not MODE_INTRA) or the coding unit (CU) size is equal to the smallest coding unit (SCU) size, then control passes to a part_mode step 1126. Otherwise control passes to the cu_type test step 1128.

If step 1126 is skipped, then ‘part_mode’ is always coded for coding units (CUs) using inter-prediction. For coding units (CUs) using intra-prediction, if the coding unit (CU) size is larger than the smallest coding unit (SCU) size, then the partition mode is inferred to be ‘PART_2N×2N’ (i.e. one prediction unit (PU) occupies the entire coding unit (CU)). If the coding unit (CU) size is equal to the smallest coding unit (SCU) size, then the partition mode is decoded from the encoded bitstream 312 and selects between either ‘PART_2N×2N’ or ‘PART_N×N’. The ‘PART_N×N’ mode divides the coding unit (CU) into four square non-overlapping prediction units (PUs).

At the decode partition mode step 1126, the entropy decoder 420, under execution of the processor 205, decodes a part_mode syntax element from the encoded bitstream 312. Note that due to the step 1122, part_mode is not decoded from the encoded bitstream 312 when the intra block copy mode is in use. In such cases, the partition mode of the coding unit (CU) may be inferred to be ‘PART_2N×2N’.

Then at the cu_type test step 1128, the prediction mode of the coding unit (CU) is tested under execution of the processor 205 by testing the coding unit type flag, cu_type. If the coding unit type flag, cu_type, indicates that the prediction mode is intra-prediction (i.e. ‘CuPredMode==MODE_INTRA’) control passes to an intra_bc_flag_test step 1030. Otherwise, control passes to an intra_pred mode step 1034.

At the intra_bc_flag test step 1130, the processor 205 is used to test if the intra block copy feature is used by the coding unit (CU). If the intra block copy feature is used by the coding unit (CU), control passes to a decode block vector step 1132. Otherwise control passes to the intra_pred mode step 1134.

Then at the decode block vector step 1132, the entropy decoder 420, under execution of the processor 205, is used for decoding a block vector for the intra copy mode from the encoded bitstream 312. The block vector is generally encoded in the encoded bitstream 312 using an existing syntax structure, such as the ‘mvd_coding’ syntax structure that is otherwise used for motion vector differences. After the step 1132, control passes to a decode root coded block flag step 1036.

At the intra_pred mode step 1134, the entropy decoder 420, under execution of the processor 205, decodes an intra-prediction mode for each prediction unit (PU) in the coding unit (CU) from the encoded bitstream 312. The intra-prediction mode specifies which one of thirty-five possible modes is used for performing intra-prediction in each prediction unit (PU) of the coding unit (CU).

Then at the decode root coded block flag step 1136, the entropy decoder 420, under execution of the processor 205, decodes a root coded block flag, rqt_root_cbf, from the encoded bitstream 312. The root coded block flag, rqt_root_cbf, specifies if there is any residual information for the coding unit (CU) (i.e. at least one significant coefficient is in any of the transform units (TUs) within the coding unit (CU)). If there is residual information associated with the coding unit (CU), then in a decode transform tree step 1138, the entropy decoder 420, under execution of the processor 205, decodes a transform tree (or ‘residual quad-tree’) from the encoded bitstream 312. The transform tree includes signalling to indicate the hierarchical structure of the residual quad-tree and residual coefficients for each transform unit (TU).

At an intra block copy step 1140, the intra block copy module 436, under execution of the processor 205, produces a reference block by copying a block (or an array) of sample values (or samples) located within the current and/or previous coding tree block (CTB). Accordingly, the sample values are determined for the reference block from the previously decoded samples. The location of the reference block is determined by adding the block vector to the co-ordinate of the current coding unit (CU). The intra block copy module 436 is thus used for decoding the sample values for the reference block from the encoded bitstream 312 based on the intra block copy flag decoded at step 1116. The copying of the block of sample values at step 1140 may be referred to as the intra block copy.

Then at a reconstruction step 1142, the prediction unit (PU) 466 (i.e. the reference block), is added to the residual sample array 456 in the summation module 424 to produce the sum 458 (i.e. the reconstructed samples). The method 1100 then terminates following step 1142.

In one arrangement of the method 1100 that accords with FIG. 8A, the intra block copy step 1140 is modified such that the ‘default value’ is used for reference samples overlapping for the unavailable neighbouring coding tree block (CTB). This arrangement is described in more detail below with reference to FIGS. 17C and 17D.

In one arrangement of the method 1100 that accords with FIG. 8B, the method 1100 is modified (e.g. in the decode block vector step 1132) such the decoded block vector (e.g. 824) is clipped to prevent any unavailable samples (e.g. 830) from being included in the reference sample block (e.g. 826).

Context selection for an intra block copy flag (e.g. 910) for a coding unit (CU), will now be described with reference to FIG. 12. As described below, the video decoder 114 may be configured for selecting a context for the intra block copy flag independently of the values of the intra block copy flag for neighbouring blocks. In the example of FIG. 12, a frame portion 1200 includes coding tree blocks (CTBs), such as coding tree block (CTB) 1202 and 1204. Coding tree blocks (CTBs) in the frame portion 1200 are scanned in raster order. Coding units (CUs) within each coding tree block (CTB) 1202 and 1204 are scanned in Z-order, as shown in FIG. 6A. A coding unit (CU) 1210 uses the intra block copy mode when signalled by an intra_bc_flag in the encoded bitstream 312.

The intra_bc_flag is coded using context adaptive binary arithmetic coding, with a context selected from one of three possible contexts. The intra_bc_flag values of neighbouring blocks are used to determine which context to use. Blocks adjacent and above (e.g. 1212), and to the left (e.g. 1214) of a current block are used, as these blocks have been decoded previously and thus the intra_bc_flag values are available to the video decoder 134. If a neighbour block is not available (e.g. the neighbour block is in a different slice or tile, or the current block is at the edge of a frame) then the neighbour block intra_bc_flag value, for the purpose of context selection, is set to be zero. A context index has a value from zero to two and is determined by adding the left intra_bc_flag value to the right intra_bc_flag value. For the purpose of the addition, intra_bc_flag values such as ‘enabled’, ‘true’ or ‘set’ are treated as a one and intra_bc_flag values such as ‘disabled’, ‘false’ or ‘clear’ are treated as a zero. When the coding tree block (CTB) has a size of 64×64 and the smallest coding unit (SCU) size is 8×8, an 8×8 array of intra_bc_flags exists within a coding tree block (CTB). Storage of the 8×8 array of intra_bc_flags is necessary in order to meet the dependencies of the intra_bc_flag context selection. Along the left edge of a coding tree block (CTB), the eight intra_bc_flags along the right edge of the previous coding tree block (CTB) may be required. Additionally, as scanning of coding tree blocks (CTBs) occurs in a raster-scan manner, an array of intra_bc_flags sufficient for coding units (CUs) sized 8×8 along a row the width of an entire frame is necessary to meet the dependency on the ‘above’ intra_bc_flag. For example, the block 1212 is located in the previous row of coding tree blocks (CTBs) and thus storage is required for the intra_bc_flag corresponding to the block 1212. The storage is provisioned for all possible block locations along the row of coding tree blocks (CTBs). In contrast, a block 1220 is not located along the top of a coding tree block (CTB) and hence the intra_bc_flag values of neighbouring blocks (i.e., 1222 and 1224).

For an HD image (i.e., 1920×1080 resolution) the required buffer size for storing the intra_bc_flags is two-hundred and forty (240) flags. For image resolutions beyond HD, several variants exist, generally referred to as “4K2K”. One variant is “Ultra HD” with a resolution of 3840×2160. Another variant is “Digital Cinema”, with a resolution of 4096×2160. The required buffer size for storing the intra_bc_flags for 4K2K resolutions is up to five hundred and twelve (512) flags. The intra_bc_flags buffer is accessed generally once per coding unit (CU), resulting in relatively high memory bandwidth for determining the context index of a single flag. For hardware implementations of the video encoder 114 and video decoder 134, on-chip static RAM may be used for buffering the intra_bc_flags. For software implementations of the video encoder 114 and video decoder 134, the intra_bc_flags buffer may reside in L1 cache, consuming valuable cache lines.

In one arrangement, the context selection of the intra_bc_flag may be simplified by using a single context for the intra_bc_flag. Such arrangements have lower complexity due to the removal of buffers to hold previously decoded intra_bc_flag values. An additional advantage of using a single context for the intra_bc_flag is obtained through reduced memory access and the avoidance of calculations to determine the context index. Generally, reducing the number of contexts available for coding a syntax element, such as the intra_bc_flag, reduces coding efficiency.

The encoded bitstream 312, produced by the method 1000 and decodable by the method 1100, only includes an intra_bc_flag for coding units (CUs) indicated to use intra-prediction (i.e. pred_mode indicates MODE_INTRA). As such, for inter-predicted coding units (CUs), the intra_bc_flag is not present in the encoded bitstream 312. An improvement in coding efficiency for inter-predicted coding units (CUs) is thus achieved, at the expense of making the intra block copy mode only available when a pred_mode syntax element indicates that use of intra-prediction for the coding unit (CU).

Generally intra-prediction produces a prediction with higher distortion than the prediction produced by inter-prediction. The higher amount of distortion in the output intra-prediction results in an increase in the amount of residual information required to further correct the distortion to an acceptable level (i.e. as derived from the quantisation parameter). The larger amount of residual information typically results in an intra-predicted frame consuming a much larger portion of the encoded bitstream 312 than an inter-predicted frame. For applications highly sensitive to coding efficiency, inter-prediction is thus used as much as possible. As such, removing the signalling of the intra_bc_flag for inter-predicted coding units (CUs) is beneficial.

FIG. 13 is a schematic block diagram showing functional modules 1302, 1304, 1306, and 1308 of the entropy decoder module 420 of FIG. 4. The modules 1302, 1304, 1306, and 1308 of the entropy decoder module 420 may be implemented as one or more software code modules of the software application program 233 implementing the video decoder module 134. The entropy decoder module 420 uses context adaptive binary arithmetic coding. The encoded bitstream 312 is provided to a binary arithmetic decoder module 1302. The binary arithmetic decoder module 1302 is provided with a context from a context memory 1304. The context indicates a likely value of the flag (or ‘symbol’) being decoded and a probability level for the flag. The context is selected according to a context index, provided by a context index determiner 1306. The context index determiner 1306 determines the context index for the intra_bc_flag by using the values of intra_bc_flag from neighbouring coding units (CUs).

FIG. 14 is a schematic flow diagram showing a method 1400 of decoding an intra block copy flag for a coding unit (CU). The method 1400 is generally performed by the entropy decoder module 420 or the entropy encoder module 324. The method 1400 may be implemented as one or more of the software code modules implementing the video decoder 134 or the video encoder 114, which are resident in the hard disk drive 210 and are controlled in their execution by the processor 205. The method 1400 is described below by way of example where the method 1400 is executed by the video decoder 134.

The method 1400 begins at an above flag available test step 1402, where the processor 205 is used to test if the intra_bc_flag in the above block (i.e., the block adjacent and above a current block) is available (e.g. derives an ‘availableA’ variable). The intra_bc_flag in the above block may be referred to as the ‘above flag’. If the current block is at the top of a frame, then the above intra_bc_flag cannot be available. If the above block is in a different slice segment to the current block then the above intra_bc_flag is not available. If the above block is in a different tile to the current block then the above intra_bc_flag is not available. If none of the above conditions are met, the above block is available (i.e. ‘availableA’ is true).

If the above intra_bc_flag is not available (i.e. ‘availableA’ is false) at step 1402, control passes to a left flag available test step 1406. Otherwise, control passes to a read above intra_bc_flag step 1404.

At the read above intra_bc_flag step 1404, an intra_bc_flag value (i.e. ‘condA’) for the coding unit (CU) above the current coding unit (CU) is read from the flag cache module 1308 configured within the memory 206 under execution of the processor 205. When the current coding unit (CU) is aligned along the top of the current coding tree block (CTB), the intra_bc_flag being read is from a coding unit (CU) belonging to the row of coding tree blocks (CTBs) above the current coding tree block (CTB). As the coding tree blocks (CTBs) are processed in raster order (within one tile) and the smallest coding unit (SCU) size is generally 8×8, one intra_bc_flag is stored in the flag cache module 1308 for every eight (8) samples of frame width. For “4K2K” frames, up to five hundred and twelve (512) intra_bc_flags are buffered (e.g., within the memory 206) in order to meet the dependency on the above intra_bc_flag. The intra_bc_flags buffer may be referred to as a ‘line buffer’ because the intra_bc_flags buffer holds information pertaining to an entire line of the frame (e.g. a line of smallest coding units (SCUs) or a line of samples).

As the intra block copy flags are accessed frequently (i.e. once per coding unit (CU)), the intra block copy flags may be stored in on-chip static RAM or in cache memory of the memory 206. Such memory in the flag cache module 1308 is costly (e.g. in terms of silicon area or in terms of memory bandwidth). When the current coding unit (CU) is not aligned along the top of the current coding tree block (CTB), the intra_bc_flag being read is from a coding unit (CU) belonging to the current coding tree block (CTB). The coding units (CUs) are scanned in a Z-scan order, according to the coding tree hierarchy of the coding tree block (CTB).

For a coding tree block (CTB) comprised entirely of coding units (CUs) of the smallest coding unit (SCU) size, an array of 8×7 (i.e. 56) intra_bc_flags is required in the flag cache module 1308 to meet the dependency on the above intra_bc_flag. The width of eight is due to the division of the coding tree block (CTB) width of sixty-four (64) samples into eight smallest coding units (SCUs). The height of seven is due to the division of the coding tree block (CTB) height of sixty-four (64) samples into eight rows of smallest coding tree units (SCUs). Seven of the eight rows are located in the current coding tree block (CTB) and one row is located in the above coding tree block (CTB) (i.e., separately buffered, as described above).

Then at a left flag available test step 1406, the processor 205 is used to determine if the intra_bc_flag for the coding unit (CU) adjacent and to the left of the current coding unit (CU) is available. The intra_bc_flag for the coding unit (CU) adjacent and to the left of the current coding unit (CU) may be referred to as the ‘left flag’. If the current coding unit (CU) is aligned to the left of the frame, the left intra_bc_flag is considered unavailable. If the left coding unit (CU) belongs to a different slice than the current coding unit (CU), the left intra_bc_flag is considered unavailable. If the left coding unit (CU) belongs to a different tile than the current coding unit (CU), the left intra_bc_flag is considered unavailable. If none of these conditions are met, the left intra_bc_flag is considered available (i.e. ‘availableL’ is false). If the left intra_bc_flag is unavailable, control passes to a determine context index step 1410. Otherwise (i.e. ‘availableL’ is true), control passes to a read left flag step 1408.

At the read left flag step 1408, the intra_bc_flag value (i.e. ‘condL’) for the coding unit (CU) adjacent and to the left of the current coding unit (CU) is read under execution of the processor 205 (i.e., read left flag). If the current coding unit (CU) is aligned along the left edge of the current coding tree block (CTB), the intra_bc_flag is read from a buffer of eight intra_bc_flags that hold the intra_bc_flag values for (up to) eight smallest coding units (SCUs) along the right edge of the previous coding tree block (CTB). If the current coding unit (CU) is not aligned along the left edge of the current coding tree block (CTB), the flag is read from a 7×8 buffer of intra_bc_flags for neighbouring coding units (CUs) of the smallest coding unit (SCU) size within the current coding tree block (CTB). The buffer size of 7×8 results from the division of the 64×64 coding tree block (CTB) into 64 (i.e. 8×8 grid) of 8×8 coding units (CUs) in the ‘worst case’, with seven columns of intra_bc_flags referenced from within the current coding tree block (CTB) and one column of intra_bc_flags reference from the previous (left) coding tree block (CTB). The 8×7 intra_bc_flag buffer for the above intra_bc_flags and the 8×7 buffer for the left intra_bc_flags mostly overlap. Due to the overlap, a single sixty-three (63) or sixty-four (64) flag buffer (i.e. an 8×8 flag buffer and the lower-right flag is not accessed and therefore may be omitted) is required in the flag cache module 1308 to provide both the above intra_bc_flags and the left intra_bc_flags within the current coding tree block (CTB).

Then at the determine context index step 1410, the context index for the intra_bc_flag for the current coding tree block (CTB) is determined under execution of the processor 205. The context index is one of zero (0), one (1) or two (2). Where the context memory 1304 is a contiguous memory holding contexts for a variety of syntax elements, an offset (not further discussed here) is implicit in the context index to point to the storage of contexts for the intra_bc_flag within the context memory 1304 configured within memory 206. The context index is the sum of the left intra_bc_flag value and the above intra_bc_flag value (Boolean values are interpreted as ‘0’ for false and ‘1’ for true). If the left intra_bc_flag is not available, the left intra_bc_flag is considered to be zero for the sum calculation. If the above intra_bc_flag is not available, the above intra_bc_flag is considered to be zero for the sum calculation. The context index may thus be represented by the formula (condL && availableL)+(condA && availableA).

At the read context step 1412, a context is read from the context memory module 1304, under execution of the processor 205, the context being selected by the context index from the determine context index step 1410.

Then at the decode bin step 1414, the context is used to decode one flag (or ‘bin’) from the encoded bitstream 312. The decoded flag corresponds to an intra_bc_flag for the current coding unit (CU).

At a store in flag cache step 1416, the decoded flag is stored in the flag cache module 1308, configured within memory 206, for future reference when decoding subsequent intra_bc_flags from the encoded bitstream 312. Also, in an update context step 1418, the context is updated, under execution of the processor 205, according to the decoded flag value. A probability and a likely bin value (i.e. ‘valMPS’) associated with the context is updated.

Then at a write context step 1420, the updated context is written back to the context memory module 1304, using the same context index as in step 1412. Following step 1420, the method 1400 concludes.

As described above, the method 1400 may also be executed by the video encoder 114, where step 1414 is modified to encode a bin (i.e. intra_bc_flag value for the current coding unit (CU)) in the encoded bitstream 312.

In one alternative arrangement of the method 1400, the above intra_bc_flag available test step 1402 is modified such that when the current coding unit (CU) is aligned to the top of the current coding tree block (CTB), the above intra_bc_flag is considered to be unavailable, even if the adjacent coding unit (CU) in the above coding tree block (CTB) is available. That is, ‘availableA’=false when the coding unit (CU) Y-co-ordinate (i.e., yCb) specifying the top-left sample of the current luma coding block relative to the top-left luma sample of the current coding tree block (CTB), is zero. In an arrangement where step 1402 is modified in such a manner, the removal of the dependency across coding tree blocks (CTBs) results in the flag cache module 1308 not needing to include buffering for the up to (512) intra_bc_flags. In an arrangement where step 1402 is modified in such a manner, the coding unit (CU) 1210 depends on the intra_bc_flag value of the block 1214 for the determine context index step 1410, whereas the coding unit (CU) 1220 depends on the intra_bc_flag values of the blocks 1222 and 1224 for the determine context index step 1410.

In another alternative arrangement of the method 1400, the above intra_bc_flag available test step 1402 and the read above intra_bc_flag step 1404 are omitted (i.e. available A is always false). In an arrangement where step 1402 and 1404 are omitted, the determine context index step 1410 is trivial because the context index is set according to only the left intra_bc_flag value resulting from the read left flag step 1408 (or zero if the left flag is not available). An arrangement where steps 1402 and 1404 are omitted, requires only two contexts in the context memory module 1304 for intra_bc_flag. Moreover, an arrangement of the method 1400 where steps 1402 and 1404 are omitted do not require memory in the flag cache module 1308 to buffer the up to 512 intra_bc_flags or the fifty six (56) intra_bc_flags for the above neighbours.

In still another alternative arrangement of the method 1400, steps 1402-1408 are omitted. In arrangements where steps 1402-1408 are omitted (i.e. availableA and availableL are always false), the determine context index step 1410 is trivial because only a single context is used for the intra_bc_flag. The context memory module 1304 thus includes only one context for the syntax element corresponding to the single context. In arrangements where steps 1402-1408 are omitted, the flag cache module 1308 may be omitted because there is no need to reference the intra_bc_flag values from neighbouring coding units (CUs) to determine the context index of the intra_bc_flag for the current coding unit (CU).

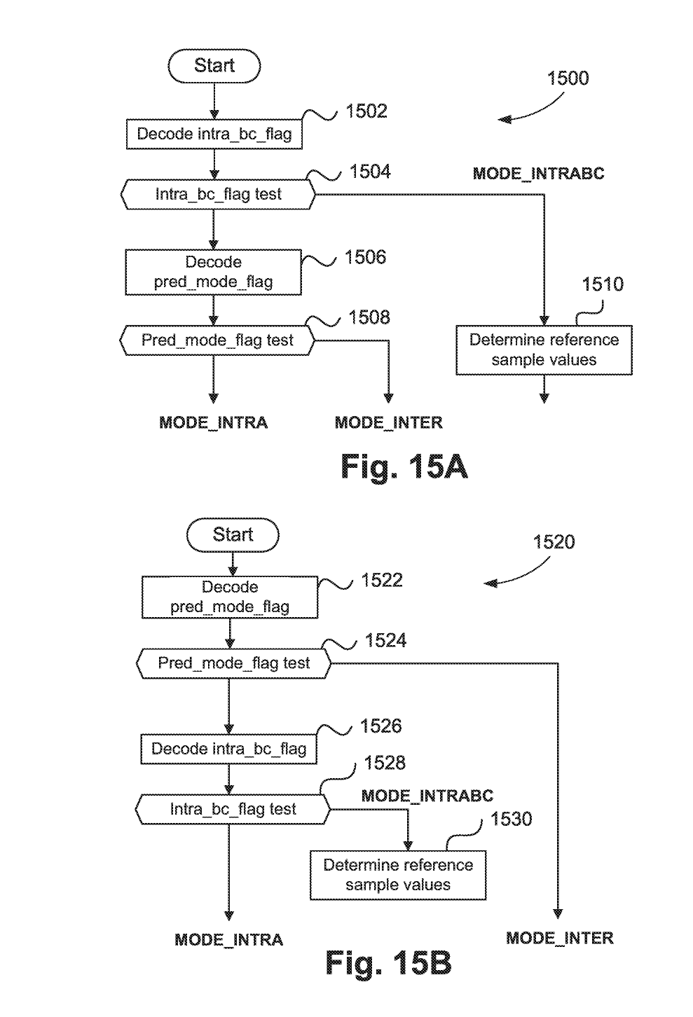

FIG. 15A is a schematic flow diagram showing a method 1500 of determining a prediction mode for a coding unit (CU), in accordance with one arrangement. The method 1500 is performed by the video decoder 134 as part of parsing a coding unit (CU) syntax structure. The method 1500 may be implemented as one or more of the software code modules implementing the video decoder 134, which are resident in the hard disk drive 210 and are controlled in their execution by the processor 205.

The method 1500 begins at a decode intra_bc_flag step 1502, where an intra block copy flag is decoded from the encoded bitstream 312 in accordance with the method 1400. The intra block copy flag is decoded from the encoded bitstream 312 for use in determining a prediction mode for the coding unit (CU).

Then at an intra_bc_flag test step 1504, if the intra block copy flag has a value of one, the prediction mode of the coding unit (CU) is known to be ‘MODE_INTRABC’ (i.e., the prediction mode for the coding unit (CU) is intra block copy mode) and control passes to a determine sample values step 1510. At the determine sample values step 1510, a block of reference sample values (or samples) is determined for the coding unit (CU), under execution of the processor 205, by performing the intra block copy step 1140 of FIG. 11 in the intra block copy module 436.

If the intra block copy flag has a value of zero, control passes to a decode pred_mode_flag step 1506. The decode pred_mode_flag step 1506 decodes a prediction mode syntax element from the encoded bitstream 312 by performing step 1116 of FIG. 11.

Then at a pred_mode_flag test step 1508, the prediction mode for the coding unit (CU) is determined according to the decoded prediction mode syntax element. A pred_mode_flag value of zero (‘0’) indicates ‘MODE_INTER’ (i.e., the prediction mode for the coding unit (CU) is inter-prediction mode) and a pred_mode_flag value of one (‘1’) indicates ‘MODE_INTRA’ (i.e., the prediction mode for the coding unit (CU) is intra-prediction mode).

FIG. 15B is a schematic flow diagram showing a method 1520 of determining a prediction mode for a coding unit (CU), in accordance with one arrangement. The method 1500 is performed by the video decoder 134 as part of parsing a coding unit (CU) syntax structure. The method 1500 may be implemented as one or more of the software code modules implementing the video decoder 134, which are resident in the hard disk drive 210 and are controlled in their execution by the processor 205.

The method 1520 comprises a subset of the steps of the method 1100 for deriving the prediction mode of the coding unit (CU).

The method 1520 begins at a decode pred_mode_flag step 1522. At the decode pred_mode_flag step 1522, a prediction mode syntax element is decoded from the encoded bitstream 312 by performing step 1116 of the method 1100 under execution of the processor 205. As described above, at step 1116, the entropy decoder 420 is used for decoding the prediction mode flag from the encoded bitstream 312 for use in determining a prediction mode for the coding unit (CU).

Then at a pred_mode_flag test step 1524, the prediction mode for the coding unit (CU) is determined according to the decoded prediction mode syntax element. A pred_mode_flag value of zero (‘0’) indicates ‘MODE_INTER’ (i.e., the prediction mode for the coding unit (CU) is inter-prediction mode), where an intra_bc_flag is not present in the encoded bitstream 312 and thus is not decoded by the method 1520. If the pred_mode_flag value is one (‘1’) control passes to a decode intra_bc_flag step 1526.

At the decode intra_bc_flag step 1526, the processor 205 is used for decoding an intra block copy flag from the encoded bitstream 312 in accordance with the method 1400. As described above, the intra block copy flag is used for indicating that current samples are based on previously decoded samples of a current frame. As such, the intra_bc_flag is decoded if and only if the pred_mode_flag has a value of one (1). If the intra block copy flag has a value of one, the prediction mode of the coding unit (CU) is assigned ‘MODE_INTRABC’ (i.e., the prediction mode for the coding unit (CU) is intra block copy mode). Otherwise, the prediction mode of the coding unit (CU) is assigned ‘MODE_INTRA’ (i.e., the prediction mode for the coding unit (CU) is intra-prediction mode).

Then at an intra_bc_flag test step 1528, if the intra block copy flag has a value of one, the prediction mode of the coding unit (CU) is known to be ‘MODE_INTRABC’ and control passes to a determine sample values step 1530. Otherwise, the prediction mode of the coding unit (CU) is known to be ‘MODE_INTRA’.

At the determine sample values step 1530, a block of reference sample values (or samples) is determined for the coding unit (CU), under execution of the processor 205, by performing the intra block copy step 1140 of FIG. 11 in the intra block copy module 436. As described above, the block of reference samples is decoded from the encoded bitstream 312 based on the decoded intra block copy flag, by determining the sample values form the reference block from the previously decoded samples.

Inter-prediction is signalled with ‘MODE_INTER’ and intra-prediction is signalled with ‘MODE_INTRA’. Intra block copy mode is signalled with ‘MODE_INTRABC’. This does not imply that intra block copy mode should have semantics similar to intra-prediction. The intra block copy mode could also be labelled with ‘MODE_INTERBC’. The semantics of the intra block copy mode share similarities with each of inter-prediction and intra-prediction and are summarised here:

A ‘block vector’ is similar to a motion vector in that a spatial offset is applied relative to the current block to select a reference block.

A ‘block vector’ is different to a motion vector in that no temporal offset exists (due to referencing the current frame) and hence the vector should not be interpreted as referencing part of the same ‘object’ that has moved since some previous frame (motion vectors are generally interpreted this way).

The reference samples for an intra-block copied coding unit are obtained from the current frame (i.e. intra-frame prediction), similar to the neighbouring samples of the intra-prediction method.

An intra block copied block should reference inter-predicted samples when constrained intra-prediction is enabled, as such a reference reduces the error resilience feature provided by constrained intra-prediction.

The residual information for an intra-block copied block is more similar to that of a motion-compensated (inter-predicted) block and hence discrete cosine transforms (DCTs) are generally preferable for use, whereas for intra-prediction, a discrete sine transform (DCT) is used for 4×4 transform blocks.

From the above described semantics it can be seen that label ‘MODE_INTRABC’ is somewhat arbitrary and should not be interpreted to imply that the semantics of intra-prediction apply uniformly to the intra block copy mode.

The methods 1500 and 1520 differ in the arrangement of syntax elements to specify the prediction mode for the intra-prediction case and the inter-prediction case. Frames using intra-prediction generally have a large amount of residual information present in the encoded bitstream 312. Consequently, the overhead of signalling the prediction mode is minor compared to the overhead of the residual information. In contrast, frames using inter-prediction generally have a small amount of residual information present in the encoded bitstream 312. The small amount of residual information present in the encoded bitstream 312 is due to the ability of the motion estimation module 338 to select a reference block from one or more reference frames, with a spatial offset, that may very closely match the frame data 310. As such, very high compression efficiency can be achieved for inter-predicted frames or coding units (CUs). In such cases, the overhead of signalling the prediction mode for the coding unit (CU) becomes a more significant portion of the data for a coding unit (CU) in the encoded bitstream 312. The method 1520 requires a single syntax element (i.e. ‘pred_mode_flag’) to signal the ‘MODE_INTER’ case. In contrast, the method 1500 requires two syntax elements (i.e. ‘intra_bc_flag’ followed by ‘pred_mode_flag’) to signal the ‘MODE_INTER’ case.

The alternative arrangements of the method 1400 described above where step 1402 is modified, where steps 1402 and 1404 are omitted or where steps 1402-1408 are omitted, may be applied at step 1502 of the method 1500 or step 1526 of the method 1520. In arrangements where the alternative arrangements of the method 1400 are applied at step 1502 or at step 1526, a reduction in the memory capacity of the context memory module 1304 is achieved.

For the arrangements of the method 1400 where step 1402 is modified or where steps 1402 and 1404 are omitted, a reduction in the memory capacity of the flag cache module 1308 is achieved. For the arrangement of the method 1400 where steps 1402-1408 are omitted, the flag cache module 1308 is absent from the entropy decoder 420 in the video decoder 134 and the entropy encoder 324 in the video encoder 114.

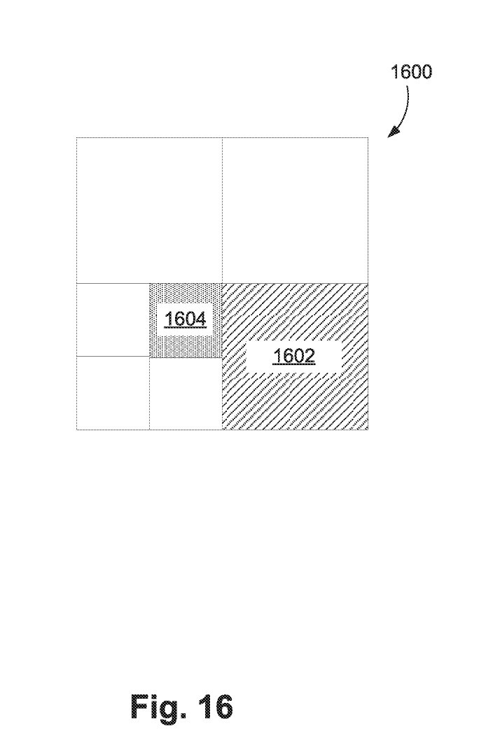

FIG. 16 is a schematic block diagram showing a residual quad-tree (RQT) 1600 in a coding unit (CU) within a coding tree block (CTB). In the example of FIG. 16, a 32×32 coding unit (CU) contains the residual quad-tree (RQT) 1600. The residual quad-tree (RQT) 1600 is sub-divided into four regions. Lower left region includes a 16×16 transform 1602. Lower right region is separately sub-divided into four more regions, of which the upper right region includes an 8×8 transform 1604. A transform may be present at any ‘leaf node’ of the residual quad-tree (RQT) (i.e. any region that is not further sub-divided). The presence of a transform at a point like a leaf node of the residual quad-tree (RQT) is signalled using ‘coded block flags’.

The video encoder 114 and the video decoder 134 support two types of transforms, the discrete sine transform (DST) and the discrete cosine transform (DCT). Only one size of discrete sine transform (DST) (i.e., a 4×4 discrete sine transform (DST)) is generally supported by the video encoder 114 and the video decoder 134. Multiple sizes of discrete cosine transform (DCT) are generally supported by the video encoder 114 and the video decoder 134, such as 4×4, 8×8, 16×16 and 32×32 discrete cosine transforms (DCT). For transform units (TUs) in the residual quad-tree (RQT) of a coding unit (CU) that includes inter-predicted prediction units (PUs), discrete cosine transforms (DCTs) are used for all transforms. For 4×4 transform units (TUs) in the residual quad-tree (RQT) of a coding unit (CU) that includes intra-predicted prediction units (PUs), 4×4 transforms are used in the luma and chroma channels. For 8×8 transform units (TUs) in the residual quad-tree (RQT) of a coding unit (CU) that includes intra-predicted prediction units (PUs), 4×4 transforms may be used in the chroma channels. In such cases, the 4×4 transform is a discrete sine transform (DST). For all other block sizes, and for transform units (TUs) in coding units that includes inter-predicted prediction units (PUs), discrete cosine transforms (DCT) are used.

The discrete sine transform (DST) performs well (i.e. provides a compact frequency domain representation) in situations with a large amount of residual information (i.e. spatial domain representation), particularly with discontinuous edges at boundaries (e.g. the transform unit (TU) boundary and the prediction unit (PU) boundary). Situations with a large amount of residual information are typical for intra-predicted prediction units (PUs).

The discrete cosine transform (DCT) performs better with ‘smoother’ spatial residual data (i.e. residual data with less discontinuous steps in magnitude in the spatial domain) results in a more compact frequency domain representation. Such smoother spatial residual data is typical of inter-predicted prediction units (PUs).

A residual quad-tree has a maximum ‘depth’. The maximum depth specifies the maximum number of quad-tree sub-divisions that are possible within the coding unit (CU). Generally, the maximum number of sub-divisions is limited to three (‘3’) hierarchy levels, although other maximum numbers of sub-divisions are also possible. Limitations on the minimum transform size may prevent the number of hierarchy levels of sub-divisions of the residual quad-tree from reaching the maximum number. For example, a 16×16 coding unit (CU) with a minimum transform size of 4×4 may only be sub-divided two times (i.e. two hierarchical levels), whereas a maximum of three was specified (e.g in high level syntax). The maximum depth is specified separately for residual quad-trees within inter-predicted coding units (CUs) and within intra-predicted coding units (CUs). For inter-predicted coding units (CUs), a ‘max_transform_hierarchy_depth_inter’ syntax element is present in high level syntax (e.g. in the sequence parameter set) to define the maximum depth.

For intra-predicted coding units (CUs), a ‘max_transform_hierarchy_depthintra’ syntax element is present in high level syntax (e.g. in the sequence parameter set) to define the maximum depth. The maximum depth of intra-predicted coding units (CUs) may be increased by one when a ‘PART_N×N’ partition mode is used. For coding units (CUs) using the intra block copy mode, the partition mode is considered to be ‘PART_2N×2N’ (i.e. one prediction unit (PU) occupies the entire coding unit (CU)).

The method 1520 may be configured to treat the partition mode as ‘MODE_INTER’ for the purposes of transform selection when the intra_bc_flag test step 1528 indicates the use of intra block copy (i.e. ‘MODE_INTRABC’). In arrangements of the method 1520 which treat the partition mode as ‘MODE_INTER’, the maximum depth of the residual quad-tree (RQT) for the coding unit (CU) is specified by max_transform_hierarchy_depth_inter. Moreover, in arrangements of the method 1520 which treat the partition mode as ‘MODE_INTER’, a discrete cosine transform (DCT) is used for all transform sizes in the residual quad-tree (RQT) of a coding unit (CU) configured for the intra-block copy mode.

FIG. 17A is a schematic flow diagram showing a method 1700 of generating a reference sample block for a coding unit (CU) configured to use the intra block copy mode. In accordance with the method 1700, the samples within the reference block are produced in conjunction with the ‘constrained intra-prediction’ feature of high efficiency video coding (HEVC). The method 1700 is performed by the video encoder 114 and the video decoder 134 when generating a reference block of a coding unit (CU) configured to use the intra block copy mode. The method 1700 may be implemented as one or more of the software code modules implementing the video encoder 114 and the video decoder 134, which are resident in the hard disk drive 210 and are controlled in their execution by the processor 205.

Inputs to the method 1700 include a block vector and samples of the current and previous coding tree blocks (CTBs) prior to in-loop filtering. The method 1700 begins at a constrained intra-prediction test step 1702, where the processor 205 is used to test if the constrained intra-prediction mode is enabled (e.g. by testing the value of a ‘constrained_intra_pred_flag’ syntax element in high level syntax, such as a ‘picture parameter set’). If the constrained intra-prediction mode is enabled, control passes to a sample prediction mode test step 1704. Otherwise, the constrained intra-prediction mode is disabled and control passes to a reference sample copy step 1708.

Then at a sample prediction mode test step 1704, the processor 205 is used to test the prediction mode of a sample within the current or previous coding tree block (CTB) referenced by the block vector relative to the sample position within the current coding unit (CU). The sample location is obtained by vector adding a block vector to the position of the corresponding sample within the coding unit (CU). If the prediction mode is ‘MODE_INTRA’ or ‘MODE_INTRABC’, control passes to the reference sample copy step 1708. Otherwise, (i.e., the prediction mode is ‘MODE_INTER’), control passes to an assign default value step 1706.

At the assign default value step 1706, a default value is assigned to the sample within the reference block, under execution of the processor 205. For example, the default value used for intra-prediction when a neighbouring sample is marked as not available for reference, may be used to assign a default value to the sample within the reference block.

At the reference sample copy step 1708, a sample from the current frame is copied to the reference block (i.e., a reference sample copy is performed), under execution of the processor 205. For example, a sample located within the current or previous coding tree block (CTB) may be copied to the reference block. The location of the sample to be copied is determined by the vector addition of the sample location within the current coding unit (CU) and the provided block vector.

All steps of the method 1700 may be performed for all samples of the reference block (i.e. iterating over a two-dimensional array of reference samples). Also, step 1702 may be performed once for a reference block and steps 1704-1708 may be performed for all samples of the reference block, with the step 1704 or 1708 invoked for each sample in accordance with the result of the result of the step 1702.

FIG. 17B is a schematic flow diagram showing a method 1720 of generating a reference sample block for a coding unit (CU) configured to use the intra block copy mode. In accordance with the method 1720, the samples within the reference block are produced in conjunction with the ‘constrained intra-prediction’ feature of high efficiency video coding (HEVC).

The method 1700 is performed by the video encoder 114 and the video decoder 134 when generating a reference block of a coding unit (CU) configured to use the intra block copy mode. Again, the method 1700 may be implemented as one or more of the software code modules implementing the video encoder 114 and the video decoder 134, which are resident in the hard disk drive 210 and are controlled in their execution by the processor 205.

Inputs to the method 1700 include a block vector and samples of the current and previous coding tree blocks (CTBs) prior to in-loop filtering. The method 1720 is functionally equivalent to the method 1700 of FIG. 17A. The difference is that the method 1720 may access samples from an inter-predicted coding unit (CU) even when constrained intra-prediction is enabled.

The method 1720 commences with a reference sample block copy step 1722. At the reference sample block copy step 1722, the entire coding unit (CU) (e.g. 842) is populated with reference samples (e.g. 846) (i.e., a reference sample block copy is performed) under execution of the processor 205. The reference samples (e.g. 846) may include samples both from intra-predicted coding units (CUs) and inter-predicted coding units (CUs) (e.g. 848).

Then at a constrained intra-prediction test step 1724, the processor 205 is used to test if constrained intra-prediction is enabled, in accordance with step 1702 of FIG. 17A. If constrained intra-prediction is disabled, the method 1720 terminates. Otherwise, control passes to a constrained overlap test step 1726.

At a constrained overlap test step 1726, if any sample of the reference block overlaps with an inter-predicted coding unit (CU), then the method 1720 terminates. Otherwise, the method 1720 proceeds to overwrite portion step 1728, where the copied samples are replaced with a default value, such as the default value used for intra-prediction reference samples when the reference samples are marked as not available for intra-prediction. The steps 1726 and 1728 may be implemented by iterating over each sample in the coding unit and testing each sample individually.

FIG. 17C is a schematic flow diagram showing a method 1740 of generating a reference sample block for a coding unit (CU) configured to use an intra block copy mode. The method 1740 may be implemented as one or more of the software code modules implementing the video encoder 114 and the video decoder 134, which are resident in the hard disk drive 210 and are controlled in their execution by the processor 205. The method 1740 is performed when generating a reference block of a coding unit (CU) configured to use the intra block copy mode. Arrangements of the video encoder 114 and the video decoder 134 may apply the method 1740 when processing a frame portion containing coding tree blocks (CTBs) from different slices or tiles, such as shown in FIG. 8A. The method 1740 is applied to each location in the coding unit (CU) (e.g. by iterating over all locations using a nested loop).

The method 1740 will be described by way of example with reference to the video encoder 114.

The method 1740 begins with a same slice and tile test step 1742.

At the same slice and tile step 1742, the processor 205 is used to test the slice of the current coding tree block (CTB) and the previous coding tree block (CTB) and the tile of the current coding tree block (CTB) and the previous coding tree block (CTB). If the two coding tree blocks (CTBs) belong to the same slice and the same tile, control passes to a reference sample copy step 1746. Otherwise, control passes to an assign default sample value step 1744.

At the assign default sample value step 1744, the intra block copy module 350 in the video encoder 114 assigns a default sample value to a sample value in the reference sample block. Alternatively, where the method 1740 is being performed by the video decoder 134, the intra block copy module 436 in the video decoder 134 performs step 1744.

At the reference sample copy step 1746, the intra block copy module 350 in the video encoder 114 copies a reference sample from a frame portion, such as the frame portion 800, to the reference sample block. Alternatively, where the method 1740 is being performed by the video decoder 134, the intra block copy module 436 in the video decoder 134 performs step 1746.

The method 1740 then terminates.

FIG. 17D is a schematic flow diagram showing a method 1760 of generating a reference sample block for a coding unit (CU) configured to use an intra block copy mode. The method 1760 may be implemented as one or more of the software code modules implementing the video encoder 114 and the video decoder 134, which are resident in the hard disk drive 210 and are controlled in their execution by the processor 205. The method 1760 is performed when generating a reference block of a coding unit (CU) configured to use the intra block copy mode. The video encoder 114 and the video decoder 134 may apply the method 1760 when processing a frame portion containing coding tree blocks (CTBs) from different slices or tiles, such as shown in FIG. 8A. The method 1760 will be described by way of example with reference to the video encoder 114. The method 1760 begins with a reference sample block copy step 1762.

At the reference sample block copy step 1762, the intra block copy module 350 in the video encoder 114 copy a block of reference samples from a frame portion, such as the frame portion 800, to the reference sample block. The block of copied reference samples may include reference samples from coding tree blocks (CTBs) belonging to different slices or tiles. Alternatively, where the method 1760 is being performed by the video decoder 134, the intra block copy module 436 in the video decoder 134 performs step 1762.

At the same slice and tile step 1764, the processor 205 tests the slice of the current coding tree block (CTB) and the previous coding tree block (CTB) and the tile of the current coding tree block (CTB) and the previous coding tree block (CTB). If the two coding tree blocks (CTBs) belong to the same slice and the same tile, the method 1760 terminates. Otherwise, control passes to a replace copied samples with default sample value 1766.

At the replace copied samples with default sample value 1766, the intra block copy module 350 in the video encoder 114 assign a default sample value to locations in the reference sample block corresponding to the previous coding tree block (CTB) (i.e. 810 in FIG. 8A). Alternatively, where the method 1760 is being performed by the video decoder 134, the intra block copy module 436 in the video decoder 134 performs step 1766.

The method 1760 then terminates.

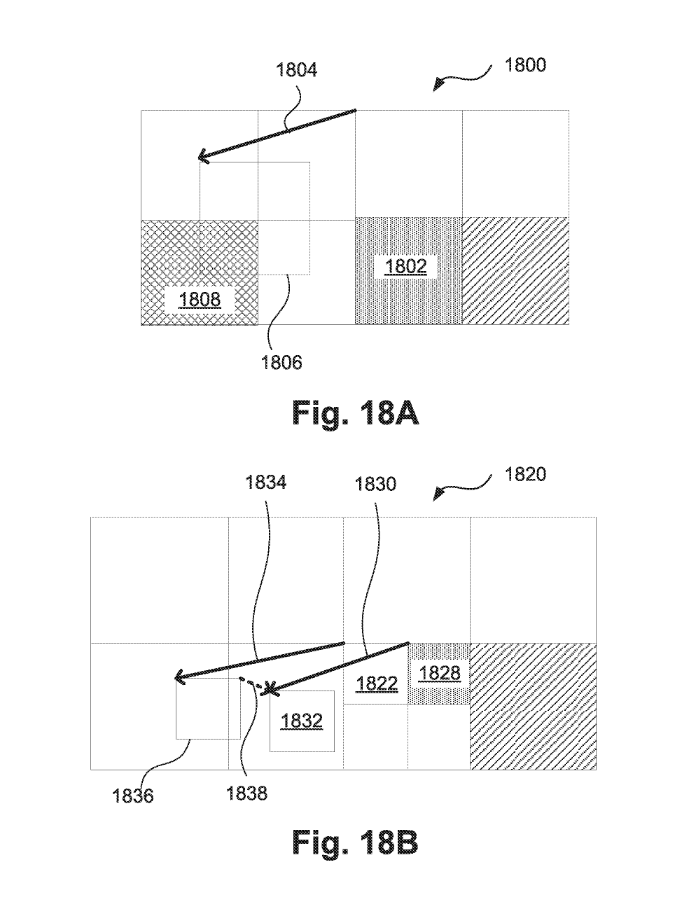

FIG. 18A is a schematic block diagram showing an example block vector 1804 referencing a reference block 1806 where the origin of the block vector 1804 is relative to a point other than the current coding unit 1802 (CU) location. As shown in FIG. 18A, the location of a reference block 1806 may be determined by vector addition of the block vector to location of an upper left corner of the current coding tree block (CTB). In arrangements where a frame portion 1800 (i.e. the current and previous coding tree blocks (CTBs) prior to in-loop filtering) are held in local storage (e.g., within the memory 206), the vector addition is not required and the block vector 1804 directly specifies the location of the reference block 1806 in the local storage. The example of FIG. 18A is in contrast to FIGS. 8A-8C where the block vector is relative to the current coding unit (CU) location.

For block vectors originating from the upper left corner of the current coding unit, the vertical displacement of a block vector is restricted to [0 . . . 56]. The maximum value of fifty-six (56) is derived by subtracting the height of the smallest coding unit (SCU) (i.e. eight (8)), from the height of a coding tree block (CTB) (i.e. sixty-four (64)). As such, there is no need to code a ‘sign’ bit for the vertical displacement in the mvd_coding syntax structure.

The horizontal displacement of a block vector is restricted to [−64 . . . 56]. For the horizontal displacement, a more even distribution of positive and negative values is expected than for block vectors relative to the current coding unit (CU) location. As such, greater coding efficiency can be expected from the use of a bypass-coded bin for the ‘sign’ bit for the horizontal displacement in the mvd_coding syntax structure.

FIG. 18B is a schematic block diagram showing an example block vector representation between successive coding units (CUs) configured to use intra block copy mode. In the example of FIG. 18B, a frame portion 1820 includes two coding tree blocks (CTBs). As seen in FIG. 18B, previous coding unit (CU) 1822 is configured to use the intra block copy mode, with a block vector 1834 configured to select reference block 1836. Current coding unit (CU) 1822 is also configured to use the intra block copy mode, with a block vector 1830 to select reference block 1832. The ordering of coding units (CUs) accords with the ‘Z-scan’ order as described with reference to FIG. 6A. In the example of FIG. 18B, a block vector difference 1838 indicates the difference between the block vector 1836 and the block vector 1832, taking into account the difference in the position of the coding unit (CU) 1822 and the coding unit (CU) 1828. The coding unit (CU) syntax structure for the coding unit (CU) 1828 encodes the block vector difference 1838 in the encoded bitstream 312, instead of the block vector 1830, using the ‘mvd_coding’ syntax structure.

In one arrangement, the video encoder 114 may calculate the block vector difference 1838 as described above and encode the calculated block vector difference 1838 into the encoded bitstream 114. In one arrangement, the video decoder 134 may decode the block vector difference 1838 from the encoded bitstream 312 and add the block vector difference 1838 to the block vector 1834 to determine the block vector 1830. Such arrangements of the video encoder 114 and the video decoder 134 achieve higher coding efficiency, as correlation between block vectors of spatially nearby intra block copied coding units (CUs) is exploited to increase the efficiency of coding the block vectors in the encoded bitstream 312. Such arrangements also require storage of one previous block vector (e.g. 1834) for computation of the current block vector (e.g. 1830). The previous block vector may be considered a ‘predictor’ (i.e. an initial value) for the current block vector. In cases where the previous coding unit (CU) was not configured to use the intra block copy mode, arrangements may reset the stored block vector to (zero, zero). Arrangements where the video encoder encodes the calculated block vector difference 1838 into the encoded bitstream 114 and where the video decoder 134 adds the block vector difference 1838 to the block vector 1834, prevent a block vector from an earlier coding unit (CU), which is unlikely to have any correlation to the block vector of the current coding unit (CU), from influencing the calculation of the block vector for the current coding unit (CU).

In one arrangement, the block vector of coding units (CUs) adjacent to the left and/or adjacent to the above of the current coding unit (CU) may also be used. In such an arrangement, additional storage for block vectors is required, including a ‘line buffer’ for ‘above’ block vectors for coding units (CUs) along the top of the coding tree block (CTB), holding block vectors from the previous row of coding tree blocks (CTBs). Further, either of the available block vectors may be used to provide a predictor for the block vector of the current coding unit (CU). Neighbouring coding units (CUs) configured to use intra block copy mode are considered ‘available’ for block vector prediction. Neighbouring coding units (CUs) not configured to use intra block copy mode are considered as ‘not available’ for block vector prediction. In cases where both the ‘left’ and ‘above’ block vectors are available, the average of the two block vectors may be used as a predictor. Alternatively, a flag may be encoded in the encoded bitstream 312 to specify which of the block vectors to use. For example, if the flag is zero the left block vector may be used as the predictor and if the flag is one the above block vector may be used as the predictor.

The arrangements described herein show methods which reduce complexity, for example, by reducing the number of contexts required to code syntax elements. The described arrangements improve coding efficiency, for example, by ordering syntax elements such that prediction mode or coding unit (CU) modes are specified in the encoded bitstream 312 in a manner optimised towards the overall frame type (e.g. inter-predicted vs intra-predicted) and by block vector coding methods. Moreover, arrangements described herein provide for error resilience by specifying intra block copy mode behaviour in situations including slice boundaries, tile boundaries, constrained intra-prediction.

### INDUSTRIAL APPLICABILITY

The arrangements described are applicable to the computer and data processing industries and particularly for the digital signal processing for the encoding a decoding of signals such as video signals.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

### APPENDIX A

The following text a coding unit (CU) syntax structure.

### 7.3.8.5 Coding Unit Syntax

| coding_unit( x0, y0, log2CbSize ) { | Descriptor |
|---|---|
| if( transquant_bypass_enabled_flag ) | |
| cu_transquant_bypass_flag | ae(v) |
| if( slice_type != I ) | |
| cu_skip_flag[ x0 ][ y0 ] | ae(v) |
| nCbS = ( 1 << log2CbSize ) | |
| if( cu_skip_flag[ x0 ][ y0 ] ) | |
| prediction_unit( x0, y0, nCbS, nCbS ) | |
| else { | |
| if( slice_type != I ) | |
| pred_mode_flag | ae(v) |
| if( intra_block_copy_enabled_flag && pred_mode_flag == 1 ) | |
| intra_bc_flag[ x0 ][ y0 ] | ae(v) |
| if( !intra_bc_flag[ x0 ][ y0 ] ) { | |
| if( CuPredMode[ x0 ][ y0 ] != MODE_INTRA \|\| | |
| log2CbSize = = MinCbLog2SizeY ) | |
| part_mode | ae(v) |
| } | |
| if( CuPredMode[ x0 ][ y0 ] = = MODE_INTRA ) { | |
| if( PartMode = = PART_2N×2N && pcm_enabled_flag && !intra_bc_flag | |
| log2CbSize >= Log2MinIpcmCbSizeY && | |
| log2CbSize <= Log2MaxIpcmCbSizeY ) | |
| pcm_flag[ x0 ][ y0 ] | ae(v) |
| if( pcm_flag[ x0 ][ y0 ] ) { | |
| while( !byte_aligned( ) ) | |
| pcm_alignment_zero_bit | f(1) |
| pcm_sample( x0, y0, log2CbSize ) | |
| } else if( intra_bc_flag[ x0 ][ y0 ] ) { | |
| mvd_coding( x0, y0, 2) | |
| } else { | |
| pbOffset = ( PartMode = = PART_N×N ) ? ( nCbS / 2 ) : nCbS | |
| for( j = 0; j < nCbS; j = j + pbOffset ) | |
| for( i = 0; i < nCbS; i = i + pbOffset ) | |
| prev_intra_luma_pred_flag[ x0 + i ][ y0 + j ] | ae(v) |
| for( j = 0; j < nCbS; j = j + pbOffset ) | |
| for( i = 0; i < nCbS; i = i + pbOffset ) | |
| if( prev_intra_luma_pred_flag[ x0 + i ][ y0 + j ] ) | |
| mpm_idx[ x0 + i ][ y0 + j ] | ae(v) |
| Else | |
| rem_intra_luma_pred_mode[ x0 + i ][ y0 + j ] | ae(v) |
| if( ChromaArrayType = = 3 ) | |
| for( j = 0; j < nCbS; j = j + pbOffset ) | |
| for( i = 0; i < nCbS; i = i + pbOffset ) | |
| intra_chroma_pred_mode[ x0 + i ][ y0 + j ] | ae(v) |
| else if( ChromaArrayType != 0 ) | |
| intra_chroma_pred_mode[ x0 ][ y0 ] | ae(v) |
| } | |
| } else { | |
| if( PartMode = = PART_2N×2N ) | |
| prediction_unit( x0, y0, nCbS, nCbS ) | |
| else if( PartMode = = PART_2N×N ) { | |
| prediction_unit( x0, y0, nCbS, nCbS / 2 ) | |
| prediction_unit( x0, y0 + ( nCbS / 2 ), nCbS, nCbS / 2 ) | |
| } else if( PartMode = = PART_N×2N ) { | |
| prediction_unit( x0, y0, nCbS / 2, nCbS ) | |
| prediction_unit( x0 + ( nCbS / 2 ), y0, nCbS / 2, nCbS ) | |
| } else if( PartMode = = PART_2N×nU ) { | |
| prediction_unit( x0, y0, nCbS, nCbS / 4 ) | |
| prediction_unit( x0, y0 + ( nCbS / 4 ), nCbS, nCbS * 3 / 4 ) | |
| } else if( PartMode = = PART_2N×nD ) { | |
| prediction_unit( x0, y0, nCbS, nCbS * 3 / 4 ) | |
| prediction_unit( x0, y0 + ( nCbS * 3 / 4 ), nCbS, nCbS / 4 ) | |
| } else if( PartMode = = PART_nL×2N ) { | |
| prediction_unit( x0, y0, nCbS / 4, nCbS ) | |
| prediction_unit( x0 + ( nCbS / 4 ), y0, nCbS * 3 / 4, nCbS ) | |
| } else if( PartMode = = PART_nR×2N ) { | |
| prediction_unit( x0, y0, nCbS * 3 / 4, nCbS ) | |
| prediction_unit( x0 + ( nCbS * 3 / 4 ), y0, nCbS / 4, nCbS ) | |
| } else { /* PART_N×N */ | |
| prediction_unit( x0, y0, nCbS / 2, nCbS / 2 ) | |
| prediction_unit( x0 + ( nCbS / 2 ), y0, nCbS / 2, nCbS / 2 ) | |
| prediction_unit( x0, y0 + ( nCbS / 2 ), nCbS / 2, nCbS / 2 ) | |
| prediction_unit( x0 + ( nCbS / 2 ), y0 + ( nCbS / 2 ), nCbS / 2, nCbS / 2 ) | |
| } | |
| } | |
| if( !pcm_flag[ x0 ][ y0 ] ) { | |
| if( CuPredMode[ x0 ][ y0 ] != MODE_INTRA && | |
| !( PartMode = = PART_2N×2N && merge_flag[ x0 ][ y0 ] ) \|\| | |
| CuPredMode[ x0 ][ y0 ] = = MODE_INTRA && intra_bc_flag[ x0 ][ y0 ] ) | |
| rqt_root_cbf | ae(v) |
| if( rqt_root_cbf ) { | |
| MaxTrafoDepth = ( CuPredMode[ x0 ][ y0 ] = = MODE_INTRA ? | |
| ( max_transform_hierarchy_depth_intra + IntraSplitFlag ) : | |
| max_transform_hierarchy_depth_inter ) | |
| transform_tree( x0, y0, x0, y0, log2CbSize, 0, 0 ) | |
| } | |
| } | |
| } | |
| } | |

### 7.4.9.5 Coding Unit Semantics

pred_mode_flag equal to 0 specifies that the current coding unit is coded in inter prediction mode. pred_mode_flag equal to 1 specifies that the current coding unit is coded in intra prediction mode. The variable CuPredMode[x][y] is derived as follows for x=x0 . . . x0+nCbS−1 and y=y0 . . . y0+nCbS−1:
If pred_mode_flag is equal to 0, CuPredMode[x][y] is set equal to MODE_INTER.
Otherwise (pred_mode_flag is equal to 1), if intra_bc_flag is equal to 0, CuPredMode[x][y] is set equal to MODE_INTRA.
Otherwise (pred_mode_flag is equal to 1 and intra_bc_flag is equal to 1), CuPredMode[x][y] is set equal to MODE_INTRABC.

When pred_mode_flag is not present, the variable CuPredMode[x][y] is derived as follows for x=x0 . . . x0+nCbS−1 and y=y0 . . . y0+nCbS−1:
If slice_type is equal to I, CuPredMode[x][y] is inferred to be equal to MODE_INTRA.
Otherwise (slice_type is equal to P or B), when cu_skip_flag[x0][y0] is equal to 1, CuPredMode[x][y] is inferred to be equal to MODE_SKIP.

### 7.4.9.9 Motion Vector Difference Semantics

The variable BvIntra[x0][y0][compIdx] specifies the vector used for the intra block copying prediction mode. The value of BvIntra[x0][y0] shall be in the range of −128 to 128, inclusive. The array indices x0, y0 specify the location (x0, y0) of the top-left luma sample of the considered prediction block relative to the top-left luma sample of the picture. The horizontal block vector component is assigned compIdx=0 and the vertical block vector component is assigned compIdx=1.

End Appendix A.

### APPENDIX B

Appendix B shows a conformance constraint for video encoders 114 and video decoders 134 for arrangements according with FIG. 8C.

It is a requirement of bitstream conformance that when constrained_intra_pred_flag is equal to 1 the value of BvIntra[x0][y0] shall be constrained such that each sample at the reference sample locations (xRefCmp, yRefCmp) is marked as “available for intra prediction”.

End Appendix B.

### APPENDIX C

Appendix B shows a conformance constraint for video encoders 114 and video decoders 134 for arrangements according with FIG. 8C.

### 8.4.4.2.7 Specification of Intra Block Copying Prediction Mode

The variable bitDepth is derived as follows:
If cIdx is equal to 0, bitDepth is set equal to BitDepth_{Y}.
Otherwise, bitDepth is set equal to BitDepth_{C}.

The (nTbS)×(nTbS) array of predicted samples samples, with x, y=0 . . . nTbS−1, are derived as follows:
The reference sample location (xRefCmp, yRefCmp) is specified by:

(xRefCmp,yRefCmp)=(xTbCmp+x+bv[0],yTbCmp+y+bv[1]) (8-65)
Each sample at the location (xRefCmp, yRefCmp) marked as “available for intra prediction” is assigned to predSamples[x][y].
At each sample at the location (xRefCmp, yRefCmp) marked as “not available for intra prediction” the value 1<<(bitDepth−1) is assigned to predSamples[x][y]

End Appendix C.

### APPENDIX D

### 9.3.2.2 Initialization Process for Context Variables

TABLE 9-4
Association of ctxIdx and syntax elements for each initializationType in the initialization
process

| | | | initType | | |
|---|---|---|---|---|---|
| Syntax structure | Syntax element | ctxTable | 0 | 1 | 2 |
| coding_unit( ) | cu_transquant_bypass_flag | Table 9-8 | 0 | 1 | 2 |
| | cu_skip_flag | Table 9-9 | | 0 . . . 2 | 3 . . . 5 |
| | intra_bc_flag[ ][ ] | Table 9-33 | 0 | 1 | 2 |
| | pred_mode_flag | Table 9-10 | | 0 | 1 |
| | part_mode | Table 9-11 | 0 | 1 . . . 4 | 5 . . . 8 |
| | prev_intra_luma_pred_flag[ ][ ] | Table 9-12 | 0 | 1 | 2 |
| | intra_chroma_pred_mode[ ][ ] | Table 9-13 | 0 | 1 | 2 |
| | rqt_root_ebf | Table 9-14 | | 0 | 1 |

TABLE 9-33
Values of initValue for ctxIdx of intra_bc_flag

| Initialization | ctxIdx of intra_bc_flag | | |
|---|---|---|---|
| variable | 0 | 1 | 2 |
| initValue | 185 | 197 | 197 |

9.3.4.2.2 Derivation Process of ctxInc Using Left and Above Syntax Elements

TABLE 9-40
Specification of ctxInc using left and above syntax elements

| Syntax element | condL | condA | ctxInc |
|---|---|---|---|
| split_cu_flag[ x0 ][ y0 ] | CtDepth[ xNbL ][ yNbL ] > cqtDepth | CtDepth[ xNbA ][ yNbA ] > cqtDepth | ( condL && availableL ) + |
| | | | ( condA && availableA ) |
| cu_skip_flag[ x0 ][ y0 ] | cu_skip_flag[ xNbL ][ yNbL ] | cu_skip_flag[ xNbA ][ yNbA ] | ( condL && availableL ) + |
| | | | ( condA && availableA ) |

End Appendix D.

1. A method of decoding a coding unit from a video bitstream, the coding unit referencing previously decoded samples, the method comprising:
determining a previous block vector of a previous coding unit to said coding unit to be decoded, the previous coding unit being configured to use intra-block copy;
decoding, from the video bitstream, a block vector difference for said coding unit to be decoded, the block vector difference indicating a difference between the previous block vector and a block vector of said coding unit to be decoded;
determining the block vector of said coding unit to be decoded using the previous block vector and the block vector difference; and
decoding said coding unit to be decoded, based on sample values of a reference block selected using the determined block vector.

2. The method according to claim 1, wherein the block vector of the coding unit to be decoded is determined using vector addition of the previous block vector and the block vector difference.

3. The method according to claim 1, wherein the block vector of the coding unit to be decoded is determined using a block vector of a coding unit selected from a set of locations adjacently left and adjacently above the coding unit to be decoded, the selection using a flag decoded from the video bitstream.

4. The method according to claim 1, wherein the previous coding unit is a coding unit preceding the coding unit to be decoded in a Z-scan order.

5. A system for decoding a coding unit from a video bitstream, the coding unit referencing previously decoded samples, the system comprising:
a memory for storing data and a computer program;
a processor coupled to said memory, the computer program comprising instructions for:
determining a previous block vector of a previous coding unit to said coding unit to be decoded, the previous coding unit being configured to use intra-block copy;
decoding, from the video bitstream, a block vector difference for said coding unit to be decoded, the block vector difference indicating a difference between the previous block vector and a block vector of said coding unit to be decoded;
determining the block vector of said coding unit to be decoded using the previous block vector and the block vector difference; and
decoding said coding unit to be decoded, based on sample values of a reference block selected using the determined block vector.

6. An apparatus for decoding a coding unit from a video bitstream, the coding unit referencing previously decoded samples, the apparatus comprising:
means for determining a previous block vector of a previous coding unit to said coding unit to be decoded, the previous coding unit being configured to use intra-block copy;
means for decoding, from the video bitstream, a block vector difference for said coding unit to be decoded, the block vector difference indicating a difference between the previous block vector and a block vector of said coding unit to be decoded;
means for determining the block vector of said coding unit to be decoded using the previous block vector and the block vector difference; and
means for decoding said coding unit to be decoded, based on sample values of a reference block selected using the determined block vector.

7. A non-transitory computer readable medium having a computer program stored thereon for decoding a coding unit from a video bitstream, the coding unit referencing previously decoded samples, the program comprising:
code for determining a previous block vector of a previous coding unit to said coding unit to be decoded, the previous coding unit being configured to use intra-block copy;
code for decoding, from the video bitstream, a block vector difference for said coding unit to be decoded, the block vector difference indicating a difference between the previous block vector and a block vector of said coding unit to be decoded;
code for determining the block vector of said coding unit to be decoded using the previous block vector and the block vector difference; and
code for decoding said coding unit to be decoded, based on sample values of a reference block selected using the determined block vector.

8. A method of encoding a coding unit into a video bitstream, the method comprising:
determining a previous block vector of a previous coding unit to said coding unit to be encoded, the previous coding unit being configured to use intra-block copy;
determining a block vector difference for said coding unit to be encoded, the block vector difference indicating the difference between the previous block vector and a block vector of said coding unit to be encoded;
encoding, into the video bitstream, the block vector difference for said coding unit to be encoded;
encoding said coding unit to be encoded into the video bitstream, using sample values of a reference block selected using the block vector of said coding unit to be encoded.

9. A system for encoding a coding unit into a video bitstream, the system comprising:
a memory for storing data and a computer program;
a processor coupled to said memory, the computer program comprising instructions for:
determining a previous block vector of a previous coding unit to said coding unit to be encoded, the previous coding unit being configured to use intra-block copy;
determining a block vector difference for said coding unit to be encoded, the block vector difference indicating the difference between the previous block vector and a block vector of said coding unit to be encoded;
encoding, into the video bitstream, the block vector difference for said coding unit to be encoded;
encoding said coding unit to be encoded into the video bitstream, using sample values of a reference block selected using the block vector of said coding unit to be encoded.

10. An apparatus for encoding a coding unit into a video bitstream, the apparatus comprising:
means for determining a previous block vector of a previous coding unit to said coding unit to be encoded, the previous coding unit being configured to use intra-block copy;
means for determining a block vector difference for said coding unit to be encoded, the block vector difference indicating the difference between the previous block vector and a block vector of said coding unit to be encoded;
means for encoding, into the video bitstream, the block vector difference for said coding unit to be encoded;
means for encoding said coding unit to be encoded into the video bitstream, using sample values of a reference block selected using the block vector of said coding unit to be encoded.

11. A non-transitory computer readable medium having a computer program stored thereon for encoding a coding unit into a video bitstream, the program comprising:
determining a previous block vector of a previous coding unit to said coding unit to be encoded, the previous coding unit being configured to use intra-block copy;
determining a block vector difference for said coding unit to be encoded, the block vector difference indicating the difference between the previous block vector and a block vector of said coding unit to be encoded;
encoding, into the video bitstream, the block vector difference for said coding unit to be encoded;
encoding said coding unit to be encoded into the video bitstream, using sample values of a reference block selected using the block vector of said coding unit to be encoded.
